(19) United States
(12) Patent Application Publication
(10) Pub. No.: US 2009/0125460 A1
(43) Pub. Date: May 14, 2009

(54) AUTOMATED HAZARDOUS MATERIALS EVENT RESPONSE SYSTEM AND METHOD

(76) Inventors: Charles Scott Hewison, San Marcos, CA (US); Stephen Allen Hollingsworth, San Marcos, CA (US); Jeffrey Anton Kacirek, Oceanside, CA (US); Richard Franklin McCrea, Oceanside, CA (US); Jesse Coronel Ortiz, JR., Vista, CA (US); Issac Baden Powell, Vista, CA (US); Karlton Devon Prillerman, Winchester, CA (US)

Correspondence Address: MORRISON & FOERSTER LLP, 12531 HIGH BLUFF DRIVE, SUITE 100, SAN DIEGO, CA, 92130-2040, US

(21) Appl. No.: 11/937,460

(22) Filed: Nov. 8, 2007

(51) Int. Cl. G06F 17/30; G06N 5/02

(52) U.S. Cl. 706/11; 706/50

(57) ABSTRACT

An automated hazardous materials event response management system and method configured to manage handling of hazardous materials events is disclosed. The materials management system can be configured to receive event information pertaining to a hazardous materials event. The system accesses an event response database, and, based on the event information, directs actions to respond to the hazardous materials event.

### FIELD OF THE INVENTION

The present invention relates generally to hazardous materials handling, and more particularly to a system and method for managing one or more events associated with hazardous materials.

### BACKGROUND OF THE INVENTION

It has been reported that there are as many as 800,000 shipments of hazardous material daily. Some 40,000 businesses are reportedly involved in transporting these materials. Additionally, manufacturing plants, retail outlets, factories, laboratories, homes and other sites store and use various forms of hazardous materials from fertilizers to paints, to pesticides, to explosives. According to the transportation department, there are more than 10,000 incidents annually involving materials such as poisonous gas, flammable solids and combustible liquids.

The United States government started regulating certain chemicals (explosives, oxidizers) as early as the 19th Century. In 1966 congress established the Department of Transportation (DOT), which is responsible for hazardous materials transportation. In 1974 congress passed the Hazardous Materials Transportation Act, giving the secretary of transportation the authority to identify and regulate all modes of hazardous materials transportation. In addition to regulations governing the transport of materials, there are rules and policies governing the storage, handling, use and cleanup of various forms of hazardous materials.

For example, federal, state and local rules can dictate how certain materials are stored, how and by whom they can be used, how they are cleaned should a spill occur and how they are transported and how they are disposed. As a result, numerous entities from auto repair facilities, to hardware stores, to factories and plants, and so on, are required to be in compliance with these rules and regulations, and may also have internal requirements as well. Additionally, record keeping and reporting requirements force these entities to follow best practices in dealing with such materials. The regulations are numerous and in many cases have become so stringent and inclusive that training, knowledge and expertise are required for persons to handle or ship hazardous materials safely and in compliance with the law.

In particular, when a material event such as a spill or other accidental release occurs, it is now necessary to not only quickly handle a potential emergency, but to do so according the rules and regulations governing the specific material released. Therefore, there is a need for systems and methods for determining proper handling techniques and protocols when a material event occurs.

### SUMMARY OF THE INVENTION

An automated hazardous materials event response management system and method configured to manage handling of hazardous materials events is disclosed. The materials management system can be configured to receive event information pertaining to a hazardous materials event. The system accesses an event response data base, and based on the event information, directs actions to respond to the hazardous materials event.

A first embodiment comprises a materials event response system. The system may include a user interface module configured to prompt a user for event information pertaining to a materials event, and receive the event information from the user. The system may also include an artificial intelligence engine module coupled to the user interface module, and configured to modify the behavior of the user interface module based on the event information. Additionally, a database module may be configured to store data pertaining to a plurality of materials. A search engine module may also be configured to search the database module to retrieve materials event handling procedure data. Also, a location information module may be configured to modify the materials event handling procedure data based on a location for the materials event. Then a results generation module, coupled to the user interface module and the data storage module may be configured to retrieve materials related data from the data storage module based on the event information and to generate a materials event response based on the materials related data.

A second embodiment comprises a method for responding to a materials event. The method comprises receiving a materials event inquiry from a user; querying an artificial intelligence engine with response information from the user, wherein the artificial intelligence engine is configured to prompt the user for response information, and change behavior based upon the response information. The method further comprises searching a material handling database for a response procedure, adjusting the response procedure based on the material or materials involved in the event and the location of the materials event, and providing a response to the materials event based on the response procedure.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and shall not be considered limiting of the breadth, scope, or applicability of the disclosure. It should be noted that for clarity and ease of illustration these drawings are not necessarily made to scale.

FIG. 1 is a block diagram illustrating an example overview of a materials management system in accordance with one embodiment of the present disclosure.

FIG. 2 is a block diagram illustrating an example process for responding to an example event in accordance with one embodiment of the present disclosure.

FIG. 3 is a block diagram illustrating an example overview of a materials management system in accordance with another embodiment of the present disclosure.

FIG. 4 is an illustration of an exemplary automatic automated hazardous materials event response management system according to embodiments of the present disclosure.

FIG. 5 shows an exemplary flow diagram of an automatic automated hazardous materials event response management process according to the embodiments of the present disclosure.

FIG. 6 is an illustration of an exemplary user interface in a blank state according to the embodiments of the present disclosure.

FIG. 7 is an illustration of an exemplary user interface in a populated state according to the embodiments of the present disclosure.

FIG. 8 shows exemplary tables 8A-8E used to populate the prompt/response profile field of user interface of FIG. 7 according to the embodiments of the present disclosure used to populate the user

FIG. 9 shows exemplary computer code for response types according to an embodiment of the present disclosure.

FIG. 10 shows an exemplary table showing a list of various actions taken based on various responses according to the embodiments of the present disclosure.

FIG. 11 shows an exemplary event trace diagram for a prompt/response sequence according to the embodiments of the present disclosure.

FIGS. 12-15 show exemplary state transition diagrams of an automated hazardous materials emergency response profile.

### DETAILED DESCRIPTION OF THE PREFERRED EMBODIMENT

In the following description of preferred embodiments, reference is made to the accompanying drawings which form a part hereof, and in which it is shown by way of illustration specific embodiments in which the disclosure may be practiced. It is to be understood that other embodiments may be utilized and structural changes may be made without departing from the scope of the preferred embodiments of the present disclosure.

The present disclosure is directed toward a system and method for providing a management system for materials handling. In one embodiment, the present disclosure provides a system and method for handling hazardous materials events of various forms and at various locations. As used herein, the term hazardous material can include any material, whether solid, liquid or gaseous, that might cause harm, is believed to cause harm, or might be suspected to cause harm, to the environment or to humans or other living organisms, regardless of how slight such harm may be, and regardless of the extent to which a causal link between a harm and the material has been established. Hazardous materials can include, for example, materials that may be flammable or explosive; materials that may be irritating or damaging to the skin, lungs or other parts of the body; materials that may be harmful or damaging to the environment; radioactive materials; carcinogens; and materials that may be considered asphyxiates, and allergens.

Before describing the disclosure in detail, it is useful to describe a few example environments with which the disclosure can be implemented. One such example is that of a retail outlet that stores various forms of hazardous material for resale to other businesses or to the public. Another example is a warehouse or other like facility used to store hazardous materials either as part of the distribution chain, or as a staging facility or for some other purpose. In these example environments, workers at the facilities may be tasked with handling the materials at various stages. For example, workers may be asked to shelve products for retail sale, assist customers with purchases of products, inventory on-hand products, fill product orders, transfer products from one shipment vessel to another, and other like activities. While these workers handle the materials on a regular basis, they may not always have the training or other specialized knowledge needed to safely handle the materials in accordance with regulations, especially, for example, in the event of a spill or other non-routine event. Another example environment is that of a materials production facility where one or more hazardous materials are manufactured either for internal use or for sale. Yet another example environment is that of a factory or business that uses hazardous materials in the conduct of its business. For example, an automobile repair facility may use petroleum products such as gasoline, diesel fuel and oil, antifreeze, asbestos, paint, aerosols, and other chemicals and materials.

Embodiments of the invention are described herein in the context of one practical application, namely, a cleanup of a hazardous material spill. In this context, the example system is applicable to provide procedures and dispatch cleanup services. Embodiments of the invention, however, are not limited to such hazardous material applications, and the methods described herein may also be utilized in other applications. One such example is that of an accidental spill or release of a hazardous material. In addressing this spill, the facility at which the spill occurred would benefit from information regarding response activities including, for example, techniques and processes for cleaning up the spill, methods for treating the environment in which the spill occurred, proper packaging and labeling of the spilled materials, maintaining accurate records regarding the spill and the various data associated with the spill, and coordinating safe and proper removal and disposal of the spilled materials. Another example event is that of cleanup of a hazardous material in accordance with good safety practices as well as any application federal state and local rules and regulations. These examples are referred to from time to time herein when describing the invention and its various features and functionality. As would be apparent to one of ordinary skill in the art after reading this description, these are merely examples and the invention is not limiting to operating in accordance with these examples.

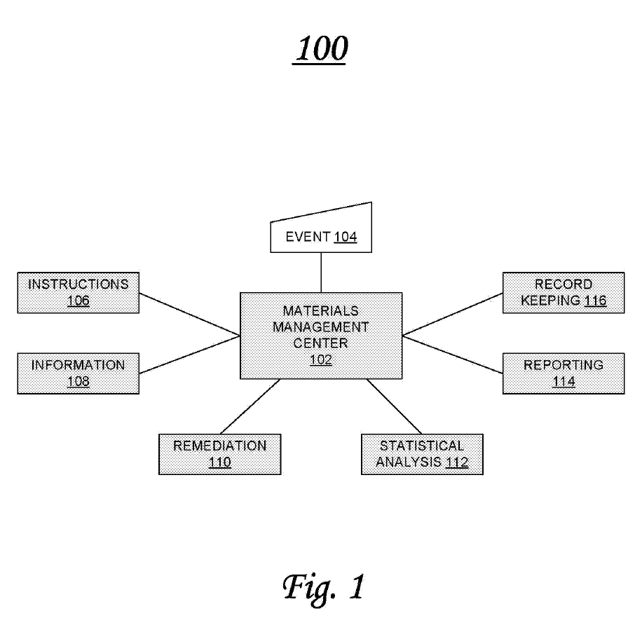

FIG. 1 is a block diagram illustrating an example overview of a materials management system 100 in accordance with one embodiment of the invention. Materials management system 100 includes a materials management center 102 that can be implemented to function as the operational engine for the materials management system 100. Materials management center 102 can be a centralized facility, or any or all of its various functions can be distributed across a plurality of facilities or locations in a geographically diverse manner. Further, the various functions described herein as attributable to materials management center 102 can be distributed to and among the various facilities it services.

Materials management center 102 preferably includes one or more computers, servers, workstations, or other data gathering, processing, computing and reporting. Preferably, materials management center 102 also includes database or other, data storage, record keeping and retrieval capabilities. Additional details regarding example implementations of a materials management center 102 in accordance with one or more embodiments of the present invention are described in greater detail below.

In operation, materials management system 100 receives an event 104 from a facility or other location that it is servicing. Events 104 can include information pertaining to a material or pertaining to an activity associated with a material at the requesting facility. For example, an event 104 can include information that a particular material is being readied for transit, that a particular hazardous material has been spilled or accidentally released, that a particular material is about to be applied or used in a given application, that a particular material is ready for disposal, or any other event associated with a material. In one embodiment, events 104 deal with materials that may have particular handling, transit, cleanup, disposal, storage or other requirements such as, for example, hazardous materials.

To facilitate a more detailed description of the invention and its various facets, the invention is described herein in terms of a few specific example events 104. After reading this description, it will become apparent to one of ordinary skill in the art how to implement the invention and several of its embodiments and features in responding to handling or otherwise managing any of a plurality of other materials-related events. One such example is that of an accidental spill or release of a hazardous material. In addressing this spill, the facility at which the spill occurred would benefit from information regarding response activities including, for example, techniques and processes for cleaning up the spill, methods for treating the environment in which the spill occurred, proper packaging and labeling of the spilled materials, maintaining accurate records regarding the spill and the various data associated with the spill, and coordinating safe and proper removal and disposal of the spilled materials.

Another example event is that of readying a hazardous material for usage or for shipment in accordance with good safety practices as well as any application federal state and local rules and regulations. These examples are referred to from time to time herein when describing the invention and its various features and functionality. As would be apparent to one of ordinary skill in the art after reading this description, these are merely examples and the invention is not limiting to operating in accordance with these examples.

Additionally, as a further example, events 104 can be automatically generated based on accumulated data such as data accumulated for a given facility. As an example of this, data gathered a particular facility may provide a cumulative total of spilled materials since the last removal event. When the total (e.g., the amount of hazardous waste on hand) for a given material, class of materials, etc. reaches a determined threshold, an event can be generated to schedule removal and disposal of the accumulated materials.

Upon receipt of an event 104 (for example notification that a particular material was spilled at a service facility), materials management center 102 queries the appropriate databases and records to determine information about the material and the proper handling of the materials so that appropriate responses can be generated. Additional information regarding the information obtained by materials management center 102 in responding to an event 104 is described below.

Upon gathering the appropriate information, materials management center 102 can generate the appropriate response which can include, for example, one or more of the following: instructions 106; information 108; remediation information 110; statistical analysis 112; reporting 114; and record keeping 116. The responses that can be generated by materials management center 102 are not limited to these responses but can include additional information, actions, and output as would be appropriate for the given application or environment.

Instructions 106 can include information such as, for example, specific information regarding the steps to follow in cleaning up the particular hazardous material that has been spilled, appropriate methods and techniques to store the spilled material, ways to treat the environment in which the material was spilled, methods for treating individuals that may have been exposed to the spilled material, and other like information and instructions. For example, if event 104 indicates that chlorine was spilled at a given facility, the instructions can include information to the facility such as to restrict access to the area until cleanup is completed, that the chlorine can be harmful if exposed to the skin and can also emit a poisonous gas, that the appropriate NIOSH/MSHA-approved full face positive pressure respirator and protective clothing should be worn (which can also be identified in the instructions), and that persons without suitable respiratory and body protection must leave the area. The instructions might also include information regarding the U.S. Department of Transportation (DOT), evacuation and transportation guidelines and the appropriate handling of containerized waste chlorine in accordance with applicable federal, state, and local health and environmental laws and regulations.

In another example where an event is not a spill of a hazardous material but instead the usage of a hazardous material, the instructions might include information on how to safely handle, use and dispose of a particular material. For example, information on whether effective ventilation should be provided, respiratory protection that should be used, eye and face protection that should be used, whether skin protection should be used, whether to avoid eating, drinking, and smoking in work areas, and so on.

Additionally, as yet another example, instructions can include special precautions for material handling and storage of the hazardous materials. For example, the information can include instructions on proper containers in which to store the material, appropriate temperature ranges for the environment in which the material is stored, incompatibility with other materials for storage, proper labeling for storage containers, shelf life or storage limits for the material, and other like information. As these few examples serve to illustrate, a variety of instructions and information can be provided to a requesting facility to provide them with the appropriate instructions for dealing with any of a number of different events 104.

Materials management center 102 can also generate information 108 in response to an event 104. Information 108 can include any information that may be relevant or pertinent to a material at a requesting facility. For example, information 108 can comprise a material safety data sheet (MSDS) or other like information for a material being handled at a requesting facility. Continuing with the previous examples of a hazardous material that has been spilled, information 108 might include, for example, a material safety data sheet for the spilled material, appropriate DOT regulations for the transportation of the material, federal, state, and local rules and regulations for dealing with the particular material, site-specific information or instructions regarding the material and its appropriate handling and any other information that may be useful or appropriate in the given circumstance.

Information and instructions in response to an event can be generated or come from data and records maintained by the materials management center. Additionally, such data can be obtained from third-party sources and other external instrumentalities. For example, where a worker may have been exposed to a hazardous material during an event, the system might retrieve information from a poison control center, and the system might patch the poison control center hotline directly to the site reporting the event.

Another response that can be provided by a materials management center 102 can include a remediation response 110. A remediation response 110 can be identification, triggering, or scheduling a remediation activity such as, for example, site inspections, materials removal, materials disposal, inventory updates, equipment or facility replacements and overhauls, and other like activities. Remediation 110 can be in response to an externally or internally generated event 104. For example, where a hazardous material has been spilled, materials management center 102 can also coordinate an appropriate remediation step such as scheduling an outside vendor to conduct the cleanup activities. In another example, where a hazardous waste material is on hand, materials management center 102 can also coordinate an appropriate remediation step such as scheduling an outside vendor to transport the accumulated materials to an appropriate disposal facility.

Thus, in addition to or instead of providing instructions 106 and information 108, materials management center 102 can coordinate the remediation activities with the facility or with a third party vendor or other service provider. In one embodiment, materials management center 102 can include a list of approved service providers for particular materials or classes of materials. Materials management center 102 can also include a list of approved service providers for particular facilities that are being serviced. With the information maintained electronically, scheduling of remediation activities can occur automatically in response to an event 104. As the examples above illustrate, remediation 110 can include transportation and disposal of hazardous materials as well as cleanup activities. Materials management center 102 can automatically schedule transportation and disposal activities with approved or certified vendors, and can send messages or other alerts to appropriate individuals that such events are ready to be scheduled.

For example, the spill of a particular material or class of materials may require immediate cleanup. In the event of such an occurrence, materials management center 102 can automatically schedule the cleanup activity and provide the appropriate notices to responsible individuals. As another example, materials management center 102 can schedule periodic or routine transportation and disposal activities such as those that occur on a regularly scheduled basis. As yet a further example, materials management center 102 can schedule transportation and disposal activities in response to a threshold or other like event. To elaborate, materials management center 102 may in one embodiment track the amounts of material accumulating at a particular facility. This system may be further configured such that when the amounts of material reach a certain threshold, transportation and disposal activities are automatically scheduled to remove the subject materials.

Materials management center 102 can also be configured to gather and to store the data and other information regarding events 104, service facilities, materials managed by the system, various rules and regulations, and other information, as illustrated by record keeping box 116. This information can be used for reporting purposes 114, historical record keeping 116, and statistical analysis 112. Various reports and other output data can be generated as an output of materials management center 102. For example, materials management center 102 can provide routine periodic reporting to the various service facilities for various purposes. As a more specific example of this, quarterly (or other period) status reports, summary reports, detailed reports or other reports outlining some or all of the information associated with the various events 104 can be generated and provided to the service facilities. In addition, as another example, periodic and event driven reporting necessary for government compliance can also be performed by materials management center in an automated fashion. Data and other information gathered during the event handling process can be catalogued for later recall in relational or other databases. This data can be pulled and compiled into reports and other information necessary to comply with various federal, state, and local reporting requirements. As these few specific examples illustrate, automated or semi-automated reporting for various purposes can be managed and effectuated by materials management center 102.

In addition to reporting 114, statistical analysis 112 can also be performed by materials management center 102 using the data gathered. Event information as well as other materials and information can be analyzed on a statistical basis and reports generated outlining the results thereof. Trend analysis, performance analysis, troubleshooting, facility analysis, material analysis, and other statistical analysis can be performed automatically or in response to user requests. As one example, data pertaining to particular events 104 might be correlated to a particular shift or particular worker at a given facility, or might be correlated to a particular type of packaging used for the subject materials. As such, in this example, remedial measures might be taken to change the packaging, update handling instructions for the packaging and so on. The results of the statistical analysis can be included with the reporting function.

Although the events described above in the examples provided refer to external events generated at a requesting facility, events 104 can be generated at any of a number of external locations or can be internally generated based on various factors. For example, events 104 can be generated internally or externally as a function of time—for example, periodic events such as regular reporting requirements, routinely-scheduled inventory events, routinely-scheduled removal and disposal events, and so on.

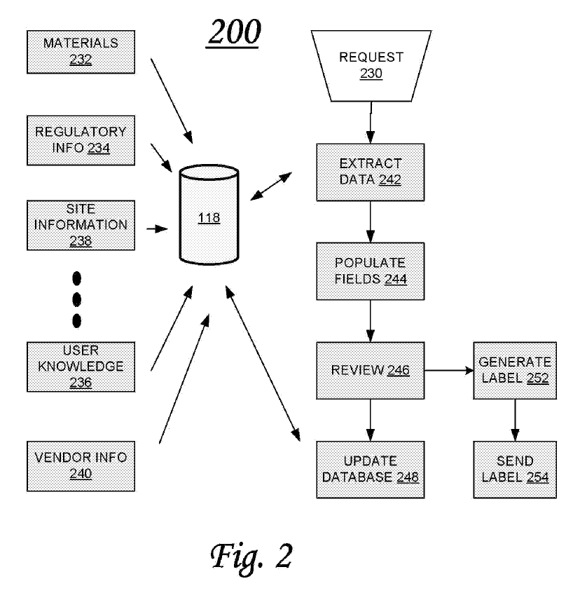

FIG. 2 is a diagram illustrating an example process 200 for responding to an example event in accordance with one embodiment of the invention. As discussed above, one feature that can be provided with a materials management system 100 in accordance with the present invention is the automated or semi-automated generation of hazardous materials information 108 in response to an event 104. One such form of information is a label that can be used for storage of hazardous materials. The example illustrated in FIG. 2 is an example of providing a hazardous materials storage label in response to a spill of a hazardous material.

A request 230 is received from a facility that is handling hazardous materials, which is herein referred to as a requesting facility. In the current example, the request 230 indicates that a particular hazardous material (or materials) has been spilled at the requesting facility. In one embodiment, the request 230 includes sufficient information to allow materials management center 102 to generate a label for the spilled hazardous material. For example, the request 230 can include information such as the identification of the requesting facility, an identification of the person making or responsible for the request, an identification of the material or materials spilled, and other information that may be useful in responding to the event.

For example, in one embodiment, the materials can be identified by a uniform or universal product code (UPC) or other product identifier to provide some level of standardization across the various service sites. The product identifier can be used as a key or other identifier to provide additional information about the product such as, for example, the specific material involved, the manufacturer, the unit package size, the MSDS sheet and so on. As another example, the requesting facility identification may be used to identify not only the facility itself, but also to identify the location of the facility (which may be useful in determining which regulations to apply), facility specific handling requirements, designated points of contact and responsible parties and so on.

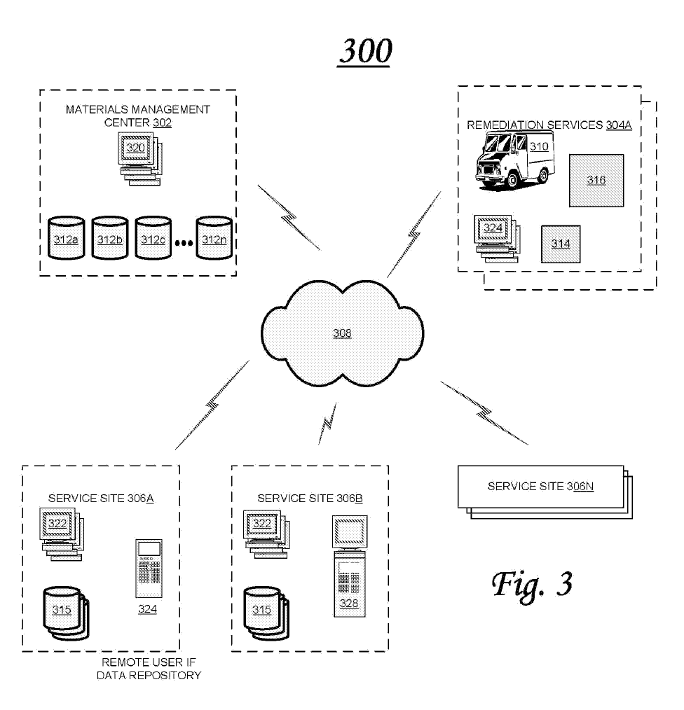

Request 230 can be received via a number of different communication mechanisms including, for example, telephone, fax, and postal service, as well as electronic messaging such as, for example, electronic mail, text message, file transfer, or any other suitable delivery mechanism. As described below with reference to FIG. 3, the various components of materials management system 102 can communicate via any of a number of various communications channels and mechanism.

Once the request 230 is received, materials management center 102 extracts the data and other information that will be used to create the requested label (task 242). This information can also be used to create the appropriate data record or data records used to maintain an appropriate history of the event for reporting and statistical purposes. For example, materials management center 102 may use the product identifier to obtain more information about the material spilled. As a more specific example, consider a case where the spilled material is a particular fertilizer. In this example, the UPC code may be used to retrieve information that the spilled material is a controlled release 15-9-12 fertilizer manufactured by the ABC fertilizer company and packaged in a twenty pound plastic bag. A UPC may also be used to retrieve information contained on the material safety data sheet for that product in either electronic or machine readable form. As this example illustrates, in this embodiment using the UPC or other product identification, a substantial amount of information 232 about the spilled material can be retrieved to assist in the creation of a label or to otherwise provide information useful for responding to the spill. As an alternative to using a UPC as a key to retrieve information, criteria for the material can be collected and assembled into a complex key by the search control. The complex key can then be used by the search control 708 to locate the material in the database. For example, a complex key consisting of a product name that contains “Sulphuric” and that is manufactured by the ABC chemical company can be assembled and used as the search criteria. In the event a specific material cannot be located, any or all of the required information can be included in the request from the requesting facility.

In response to the request, 230 materials management center 102 can also extract regulatory information 234 to be used in generating the label. For example, regulatory information 234 can include state, federal, and local regulations outlining procedures and practices for handling the material spilled. In one embodiment, the UPC or other product identifier can be used to extract the appropriate set of regulatory information 234 that pertains to that particular product or to that class of products. For example, in the case of the 15-9-12 controlled release fertilizer described above, materials management center 102 may determine that there are particular federal, state, and local regulations dealing with the cleanup and transportation of the product as well as for the disposal of the product in an approved land fill disposal facility.

Materials management center 102 can also extract site specific information 238 that may exist relevant to the particular service site 238 or class of service site 238 that is making the request. For example, the service site may have particular clean-up, handling, or other requirements used to address materials handling events. As another example, the location of the site may dictate particular local regulations that apply. As still another example, site specific information may dictate the form of the response (e.g., fax, email, etc.), to whom the response is sent, and so on. In one embodiment, the site identification information included with request 230 can be used as a key to retrieve the site specific information 238 used in generating the response to the request.

Although the majority of the information used to generate a label and other material handling instructions is gathered and accumulated in an automated fashion in one embodiment, it is contemplated that there are instances where user knowledge may be used to supplement this information. For example, skilled users trained in handling various materials may be available to provide expertise and guidance in dealing with the particular material that is spilled (or in responding to another type of event). As such, user knowledge 236 can be provided as a component of information that is used in responding to request 230. For example, user knowledge may be entered by an operator via a keyboard or other user input device. The user knowledge may supplement the label, may provide additional handling instructions or other information to the facility, may be used to annotate the historical record, and so on.

Depending on the configuration, the system can also retrieve additional information such as, for example, remediation services information. In one example, various affiliated, internal and third-party vendors and their capabilities can be included in the database to allow the system to identify and even schedule an appropriate vendor for handling the given event. For example, in the event of a spill of a particular material, one or more vendors identified as being certified or approved for handling such spills (for example, cleanup, transportation and disposal) can be identified in the database and their information 240 retrieved in response to the request 230. Thus, contact and other information for these one or more vendors can be included in the response to the request. Additionally, in one embodiment, the system can automatically schedule a vendor from the approved vendor list to conduct remediation or removal activities. As a further example, a service site 238 may identify a preferred vendor or a group of preferred vendors for various services. As such, when that service site 238 is identified in a request 230, information regarding that particular service site's preferred vendors can be retrieved from the database.

The appropriate information is then extracted from the various data repositories, and information used to respond to the request 230 is populated in various fields (task 244). For example, in one embodiment, one or more display screens are provided to an operator and include the extracted information. This information can be reviewed by the user for accuracy and completeness. Additionally, the user can update, edit, or add additional information that may be useful or necessary in responding to the request.

The materials management center 102 can update one or more databases to maintain a record of the events that transpired (task 248). For example, information pertaining to the date and time of the event, the facility at which the event occurred and its location, an identification of the material or materials involved, quantities of materials involved, actions recommended and taken, event closure and other such information can be recorded in the database for record keeping, reporting, and statistical analysis purposes.

With the information complete, an appropriate label is generated and includes information retrieved in response to the request (task 252). The label is sent to the requesting service site 238 to complete the response to the request (task 254). As stated above, the label can be sent by any of a number of transmission means including facsimile, e-mail, electronic messaging, file transfer, postal delivery, or any other communication mechanism. The label can then be affixed to the bin or other container housing the spilled materials in accordance with applicable regulations.

FIG. 3 is a block diagram illustrating an exemplary overview of a materials management system 300 in accordance with one embodiment of the present disclosure. In this example, materials management system 300 may include a materials management center 302, remediation services 304, and service site 306. Various elements 302/304/306 of the materials management system 300 may communicate via communications network 308.

The materials management center 302 may be implemented to function as the operational engine for the materials event management system 300. As mentioned above, materials management center 302 can be a centralized facility, or any or all of its various functions can be distributed across a plurality of facilities or locations in a geographically diverse manner. Further, the various functions described herein as attributable to materials management center 302 can be distributed to and among the various facilities it services. Materials management center 302 preferably includes one or more computers, servers, workstations, or other data gathering, processing, computing and reporting. Preferably, materials management center 302 also includes databases or other, data storages, record keeping and retrieval capabilities. Additional details regarding example implementations of a materials management center 302 in accordance with one or more embodiments of the present invention are described in greater detail below. The exemplary embodiment of materials management center 302 is illustrated as including one or more computers or work stations 320 to facilitate operation thereof. Materials management center 102 can also include one or more databases 312a, 312b, 312c to 312n (where n represents total number of databases) to store the various data and other information used in the materials management process. As the above examples illustrate, data can be maintained relating to federal, state, and local rules and regulations governing material handling (including shipment, storage, usage and disposal), material data and information, client specific information and other information used in the process of managing the various materials. Although separate database units are illustrated, data storage can be across any physical or logical data storage architecture, and any of a number of database models can be implemented. In one embodiment, a relational database structure is used to facilitate creation of responses from various separate sources of data.

As stated above, materials management center 302, whether centralized or distributed, can in one embodiment provide materials management functionality to a plurality of service sites 306 in geographically diverse locations. The example illustrated in FIG. 1 depicts service sites 306A, 306B to 306N (where N represents total number of service sites) illustrating that multiple service sites 306 of different types and configurations can be serviced by the material management center 302 in one embodiment.

Materials management center 302 can also generate information in response to an event. Information can include any information that may be relevant or pertinent to a material at a requesting facility. For example, information can comprise a material safety data sheet (MSDS) or other like information for a material being handled at a requesting facility. Continuing with the previous examples of a hazardous material that has been spilled, information might include, for example, a material safety data sheet for the spilled material, appropriate DOT regulations for the transportation of the material, federal, state, and local rules and regulations for dealing with the particular material, site-specific information or instructions regarding the material and its appropriate handling and any other information that may be useful or appropriate in the given circumstance.

Materials management center 302 can also be configured to gather and to store the data and other information regarding events, service facilities, materials managed by the system, various rules and regulations, and other information. This information can be used for reporting purposes, historical record keeping, and statistical analysis. Various reports and other output data can be generated as an output of materials management center 302. For example, materials management center 302 can provide routine periodic reporting to the various service facilities for various purposes. As a more specific example of this, quarterly (or other period) status reports, summary reports, detailed reports or other reports outlining some or all of the information associated with the various events can be generated and provided to the service facilities. In addition, as another example, periodic and event driven reporting necessary for government compliance can also be performed by materials management center in an automated fashion. Data and other information gathered during the event handling process can be catalogued for later recall in relational or other databases. This data can be pulled and compiled into reports and other information necessary to comply with various federal, state, and local reporting requirements. As these few specific examples illustrate, automated or semi-automated reporting for various purposes can be managed and effectuated by materials management center 302.

As mentioned above, in addition to reporting, statistical analysis can also be performed by materials management center 302 using the data gathered. Event information as well as other materials and information can be analyzed on a statistical basis and reports generated outlining the results thereof. Trend analysis, performance analysis, troubleshooting, facility analysis, material analysis, and other statistical analysis can be performed automatically or in response to user requests. As one example, data pertaining to particular events might be correlated to a particular shift or particular worker at a given facility, or might be correlated to a particular type of packaging used for the subject materials. As such, in this example, remedial measures might be taken to change the packaging, update handling instructions for the packaging and so on. The results of the statistical analysis can be included with the reporting function.

Although the events described above in the examples provided refer to external events generated at a requesting facility, events can be generated at any of a number of external locations or can be internally generated based on various factors. For example, events can be generated internally or externally as a function of time—for example, periodic events such as regular reporting requirements, routinely-scheduled inventory events, routinely-scheduled removal and disposal events, and so on.

In one embodiment, materials management center 302 is implemented to provide a centralized management center for providing materials management services, features and functions. In alternative embodiments, the services, features and functions provided by materials management center 302 as described herein can be distributed across a plurality of various facilities or locations as would be apparent to one of ordinary skill in the art after reading this description.

As stated above, in one embodiment, materials management center 302 is configured to provide various facilities with an appropriate response upon the occurrence of one or more events. Examples of a few possible configurations for such requesting facilities are provided and referred to as service sites 306 in FIG. 3. Examples of specific types of service sites 306 can include materials manufacturing plants, shipping and transportation companies, warehouses, retail facilities, factories, and so on. As such, in various embodiments of the invention, materials management center 302 or other like mechanism can be provided to perform a variety of materials management functions in support of these various service sites. For example, a retail store, automobile service facility, warehouse, or other service site 306 may handle various forms of hazardous materials on a daily basis, yet it may not be practical for such a service site 306 to itself maintain the knowledge and other skill sets necessary to properly handle the materials it deals with on a daily basis. As such, materials management center 302 in communication with one or more service sites 306 can provide the services, instructions, information, reporting, and other responses that service sites 306 may use, exclusively or as a complement to their own capabilities, to properly handle hazardous materials in the course of their business.

Remediation service 304 may include transportation and disposal services that can be used to remove hazardous waste from a requesting facility, transport hazardous materials from one location to another, and otherwise provide materials transportation services. An additional example of a remediation service 304 is a cleanup service. These and other remediation services 304 can be managed by materials management system 300. More particularly, in one embodiment, they can be managed and scheduled utilizing materials management center 302. As described above, in one embodiment the scheduling of such resources can be performed automatically by materials management center 302 in response to various threshold monitors and triggering events.

In one embodiment, where remediation services 304 are provided by outside vendors, an approval or certification process can be implemented to ensure that appropriate services are provided for a given event. For various vendors, various levels of certification may be available when approving vendors for certain of the provided services. For example, government licenses, government and private-party certifications, service site 306 approval, and materials-management-system certifications, to name a few, can be required to qualify or certify particular vendors.

As a further example, vendors may be required to have certain levels of experience, particular training and expertise, particular equipment and materials, in-depth knowledge the workings of materials management system 300 (at least as it relates to the vendor), the ability to properly tie into the system to share data, and other levels of skill, training, and experience. Thus, a given level of performance, experience and expertise can be required from the various remediation service providers to be approved by the system. In addition to levels of certification, various vendors may be placed on lists for various service facilities. For example, a particular service facility may maintain a list of its own vendors that it prefers to deal with for particular services or functions. In one embodiment, services sites 306 are provided with the ability to maintain and update their own vendor service provider lists for various services and functions such that materials management center 302 can schedule remediation resources based on approved vendors. Vendors and the various lists can be ranked in order of preference as well to enable prioritization of the choice of vendors.

Remediation services 304 can also be provided with remote user interfaces. Remediation services 304 can also be provided with certain access to kiosks at service sites 306, their own computer interfaces, or otherwise access to the IT infrastructure of materials management system 300. The level of access may be appropriately restricted to allow the remediation services 304 to have the ability to obtain, edit, and create only that information used for scheduling, performing and reporting the service. In other embodiments, remediation services 304 can be granted full access to the system or other partial access as may be deemed appropriate for the particular service provider or for the event to which they are responding. Thus, in this way, remediation services 304 can operate as an integral part of materials management system 300.

For example, service requests to a remediation services 304 provider can be provided electronically via e-mail, text messaging, electronic messaging, or other electronic means to provide scheduling requests to a desired service provider (although other communication mechanisms can be provided as well). Service requests can include detailed information about the service to be performed such as, for example, a service location (for example, at a requesting facility) the type of services to be performed, the materials involved, and a schedule for completing the services.

To better illustrate this point, consider an example where a remediation services provider is called to remove a plurality of hazardous waste materials from a particular service site 306. In making the request, materials management center 302 can provide a copy of the request to the desired remediation services 304 provider as well as to appropriate personnel at the affected service site 306. In this example, the request can also include a complete listing of materials that the vendor is to pick up at the service site 306 for removal and disposal. Thus, the service provider's schedule and shipping manifest along with other pertinent information can be provided electronically along with the request.

The contacted service provider can accept the request to confirm the appointment. Upon arrival at the designated service site 306, the vendor can log the materials that he or she actually receives for transportation and disposal. For example, a portable device such as a remote user interface 324 can be used by the remediation service 304 provider to scan in each item that is picked up for removal, although manual or other automated means can also be used to log materials. As the items are scanned in, or otherwise entered at the kiosk, remote user interface, or other terminal, the items verified as picked up for transport can be cross checked against the inventory list, manifest, or other data to ensure that there is correlation between the requested task and that which actually occurs. Similar logging and checking functions can occur at the disposal site as well. As such, with electronic entry and monitoring of the transportation and disposal process the system can track whether each of the items have been properly handled and accounted for. This information can be used in the recordkeeping, statistical analysis, and report generation functions to facilitate and enhance the functionality of the system.

Information and instructions in response to an event can be generated or come from data and records maintained by the materials management center. Additionally, such data can be obtained from third-party sources and other external instrumentalities. For example, where a worker may have been exposed to a hazardous material during an event, the system might retrieve information from a poison control center, and the system might patch the poison control center hotline directly to the site reporting the event.

Another response that can be provided by a materials management center 302 can include a remediation response. A remediation response can be identification, triggering, or scheduling a remediation activity such as, for example, site inspections, materials removal, materials disposal, inventory updates, equipment or facility replacements and overhauls, and other like activities. Remediation can be in response to an externally or internally generated event. For example, where a hazardous material has been spilled, materials management center 302 can also coordinate an appropriate remediation step such as scheduling an outside vendor to conduct the cleanup activities. In another example, where a hazardous waste material is on hand, materials management center 302 can also coordinate an appropriate remediation step such as scheduling an outside vendor to transport the accumulated materials to an appropriate disposal facility.

Thus, as mentioned above, in addition to or instead of providing instructions and information, materials management center 302 can coordinate the remediation activities with the facility or with a third party vendor or other service provider. In one embodiment, materials management center 302 can include a list of approved service providers for particular materials or classes of materials. Materials management center 102 can also include a list of approved service providers for particular facilities that are being serviced. With the information maintained electronically, scheduling of remediation activities can occur automatically in response to an event. As the examples above illustrate, remediation can include transportation and disposal of hazardous materials as well as cleanup activities. Materials management center 302 can automatically schedule transportation and disposal activities with approved or certified vendors, and can send messages or other alerts to appropriate individuals that such events are ready to be scheduled.

For example, the spill of a particular material or class of materials may require immediate cleanup. In the event of such an occurrence, materials management center 302 can automatically schedule the cleanup activity and provide the appropriate notices to responsible individuals. As another example, materials management center 302 can schedule periodic or routine transportation and disposal activities such as those that occur on a regularly scheduled basis. As yet a further example, materials management center 302 can schedule transportation and disposal activities in response to a threshold or other like event. To elaborate, materials management center 302 may in one embodiment track the amounts of material accumulating at a particular facility. This system may be further configured such that when the amounts of material reach a certain threshold, transportation and disposal activities are automatically scheduled to remove the subject materials.

Additionally, materials management system 300 can include one or more appropriate remediation services 304 to provide remediation supplies and services to the various service sites 306. For example, a hazardous materials transportation and disposal service 310 may be included to provide specialized transportation of hazardous materials in accordance with applicable rules and regulations. Such services can be provided by either independent operators, or operators who are somehow affiliated with materials management center 302, or one or more service sites 306, for example.

As discussed above, the appropriate response can include responses such as instructions regarding how to deal with the event, information pertaining to the event and the materials involved, scheduling or coordination of remediation and other activities and other like responses as described herein.

The service site 306 represents a subscriber to the materials management center 302. In the illustrated example, two particular service site 306 configurations are illustrated as service site 306A and service site 306B. Each of these example configurations are now described, although other service site 306 configurations are contemplated within the spirit and scope of the current invention.

To better describe a configuration of service site 306A it is useful to describe it in terms of a specific example. Consider the example where service site 306A is a retail establishment that sells various hazardous materials (for example, fertilizers, paints, cleaning supplies, and so on), maintains an inventory of such materials, and may even use such materials for its own purposes as well as for retail sale. Whether the retail establishment is a large national chain or a small, local mom-and-pop organization, most retail establishments include some form of computerization to assist in their retail sales operation.

Service site 306A is illustrated as including one or more computers or servers 322, one or more data repositories 315 and a remote user interface 324. For example, terminals at the loading dock may be used to enter information regarding materials received, while cash registers or other point of sale terminals may be used to monitor the sale of materials from inventory. Each of these systems can be connected to a computers 322 and data repository 315 to maintain an accurate record of materials inventory and other operations. Computers 322 and data bases 315 may be dedicated devices, configured to perform the materials management functions. In other environments, computers 322 and data bases 315 may be those used for other operations at the retail location that have been provided with the software or other capabilities to perform the materials management functions described herein. Various levels of integration between computers 322, databases 315 and other facility resources can be provided as may be desired to facilitate operations. For example, a closely integrated system may allow traditional systems such as cash registers to automatically feed information that may be used by materials management center 302 to track materials inventory.

The user at service site 306A can also enter additional information into remote user interface 324 or other interface. For example, the user may enter the type of event that is being registered. In the case of the current example, the user would identify that the material in question has been spilled and this would result in an event being generated being sent to materials management center 302 for an appropriate response. The event may be generated either automatically, or in response to further user input. Additionally, alerts or other messages can be sent to appropriate personnel in addition to or as a part of event.

In the illustrated embodiment, one or more remote user interface 324 can also be included to allow remote and portable access to service site 306 computers 322 as well as materials management center 302 (or other aspects of materials management system 300 from various locations in or near the service site 306A). For example, remote user interface 324 can be a bar code scanner, RFID tag reader, manual input device (touch screen, keypad, voice recognition, etc.), or other device that enables a user to input information pertaining to a material or materials being handled. Remote user interface 324 are not necessarily limited to hazardous materials management functions, but can also be used in the conduct of other facility operations. In one embodiment, portable terminals currently used by employees at retail establishments to check inventory, check prices, and perform other conventional tasks can also be used to facilitate materials management in accordance with the present invention.

To better illustrate the functionality that can be included with a remote user interface 324, consider an example where a material such as a fertilizer or other hazardous material is spilled within the retail sales facility. A worker at the retail outlet can use the remote user interface 324 to input information regarding the spill or to retrieve instructions and other information that may be useful in dealing with the spill. For example, the remote user interface 324 can be used to scan a bar code, RFID tag, or other product identifier to enable identification of the material in question. Alternatively, the user can key-in or otherwise manually enter information pertaining to the product that was spilled.

In one embodiment a UPC (Uniform Product Code) can be used to identify the product. In an implementation of this embodiment, the UPC can be used as a code to retrieve additional information about the product, regardless of whether such retrieval will be performed at the service site 306, at materials management center 302 or at some other location within or associated with materials management system 300.

Although two exemplary configurations for a service site 306 have been provided, these examples will serve to illustrate to one of ordinary skill in the art after reading this description that other configurations and architectures for service site 306 can be implemented to achieve the features and functions of the materials management system 300 as described herein. Additionally, the materials management system 300 can be implemented in such a way as to be scaled to handle a large number of various and diverse service sites 306.

The communications network 308 represents the communication methods employed in the materials management system 300. Although a single network cloud is depicted in FIG. 3, communications among the various elements of materials management system 100 can take place via any of a number of different communication channels or mechanisms, and are not necessarily confined to communication across a single local or wide area network. For example, communication elements such as the internet, the public switched telephone network (PSTN), other public and private networks, cellular links, satellite links, and other communication channels can be used alone or in various combinations to provide the elements of communications between and among the various components of materials management system 300. Thus, it is not necessary that all communication among the elements flow through a single communication network.

In one embodiment, remote user interface 324 can be implemented as a hand-held, battery operated device with a wireless interface allowing the user with flexibility and mobility of operation. In addition to wireless communications, a hard wired interface can be included including, for example, a docking station, cradle, or other like device to allow the remote user interface 324 to be charged as well as to transfer data to other components within the materials management system 300. A wired or wireless communication link between the remote user interface 324 and computers 322 can be provided to facilitate communication between the devices. Additionally, in one embodiment, a direct communication link between a remote user interface 324 and other elements of the materials management system 300 (including, for example, materials management center 302) can be provided as well.

The various elements of materials management system 300 may also include various communication components to enable communications among themselves as well as with outside entities. For example, communications interfaces to enable communication across network 308 or other communication channels between and among the various material management system components can be provided. The depicted example illustrates a communications interface implemented via a network 308.

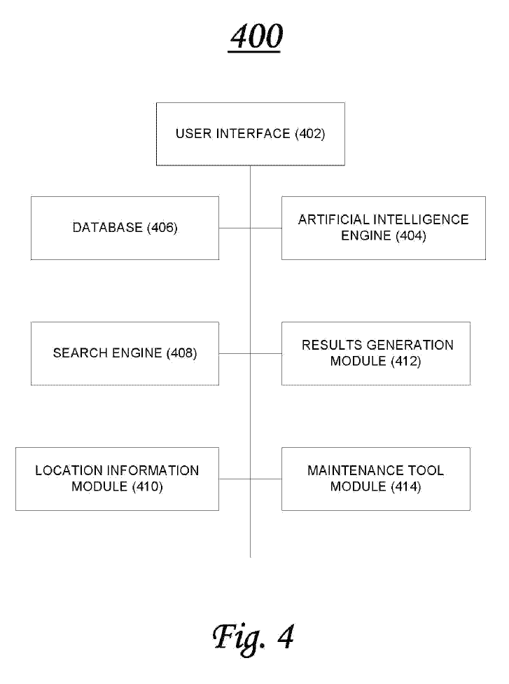

FIG. 4 is an illustration of an exemplary automated hazardous materials event response management system 400 that may be implemented at the materials management center 302 according to an exemplary embodiment of the invention. In this example, the automated hazardous materials event response management system 400 may include a user interface module 402, an artificial intelligence engine module 404, a database module 406, a search engine module 408, a location information module 410, and a results generation module 412. The components work together to provide rapid response and remediation during and after a hazardous materials release incident. The automated hazardous materials event response management system 400 may also include a maintenance tool module 414. In one embodiment, the system 400 is activated and provided as a web-based service to a user that accesses a web server at the management center 302. Various protocols for providing the web based services such as Simple Object Access Protocol (SOAP), Representational State Transfer (REST), and the like are known in the art.

The term “module” as used herein, refers to software, firmware, hardware, and any combination of these elements for performing the associated functions described herein. Additionally, for purpose of discussion, the various modules are described as discrete modules; however, as would be apparent one of skilled in the art, two or more modules may be combined to form a single module that performs the associated functions according the embodiments of the present disclosure.

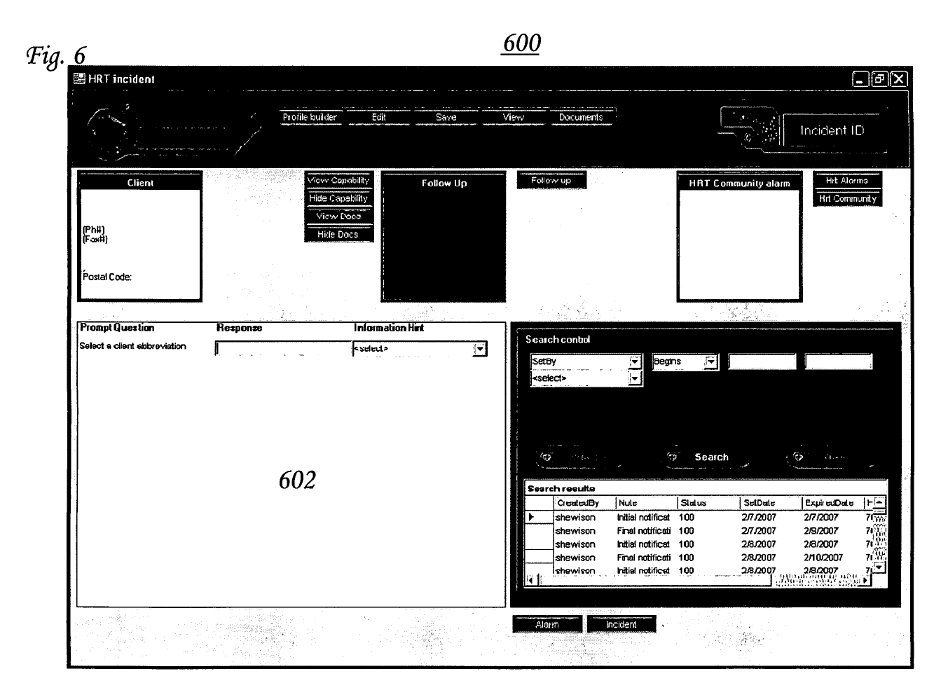

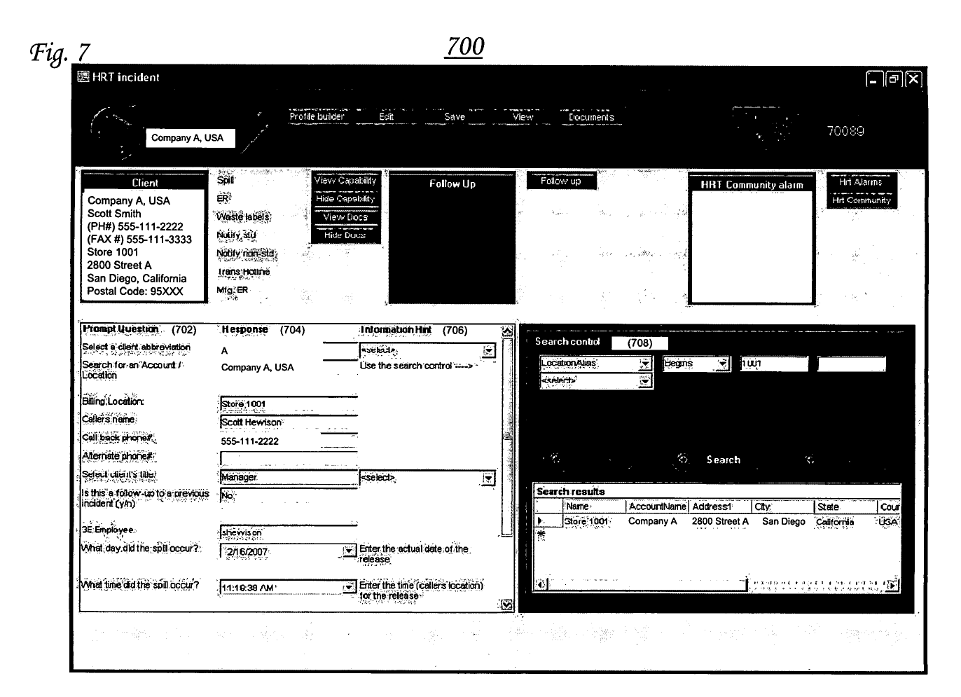

The user interface module 402 provides a graphical user interface (GUI) configured to prompt a user for event information pertaining to a materials event, and receive the event information from the user. In a further embodiment, the user interface module 402 is provided to a user or an employee located at the management center 302 who is assisting a customer located at a service site 306. Exemplary embodiments of a GUI provided by the user interface module 402 are described in more detail below in the context of FIGS. 6-7.

In one embodiment, a user may be provided with access information to log onto the materials management center 302 from his or her home, from a service site 306 or from some other remote location via communication network 308 (e.g., Internet). Such access may be via numerous mechanisms such as a personal computer or laptop; a PDA, smartphone or other handheld computing device; a telephone; or other appropriate interface mechanism. As such, personnel may maintain contact with the system from various locations. For example, managers or other appropriate personnel from a service site 306 may be able to log on to the system to monitor operations affecting their facility (including real-time monitoring), generate needed or useful reports, review data, reports and statistics, and other like operations.

The artificial intelligence engine module 404 coupled to the user interface module 402, and configured to modify the behavior of the user interface module 402 based on the event information provided by the user. The artificial intelligence engine module 404, controls the sequence of prompts provided to the user based on one or more responses to previous prompts displayed by the user interface module 402. In one embodiment, the artificial intelligence engine module 404 dynamically builds the succession of prompts based on response data collected from previously received responses. Thus, the artificial intelligence engine module 404 according to the present disclosure provides an interactive, powerful and flexible method of obtaining event information, which leads to greater accuracy of data collection and remediation measures recommended because the succession of prompts are customized to the specific materials event. It further allows streamlined data entry and increases screen real-estate by allowing a user to traverse different applications, screens or tabs to accomplish his task in accordance with previous responses received. The application can thus grow to accommodate new requirements as they arise.

For example: the business rules regarding the handling of a specific material may change. The change can come as a result of external factors such as new agency requirements, or changes in the way a client wants the material handled. New requirements can also be driven by internal factors such as a change in the service, new technology that becomes available, or automating a process that was handled manually. The change may even be specific to a client or location; in which case the original or base sequence of prompts must be maintained while accommodating a variation in the profile for the specific case. The sequence of prompts and the underlying intelligence may be altered accordingly. As an alternative to altering the base set of prompts, each client can have his own custom set of prompts. The custom set of prompts leverages the applicable business logic from the base set of prompts and implements new business logic as necessary. The end user experience is the same however. They are simply presented with a different set of prompts when the specific client is serviced.

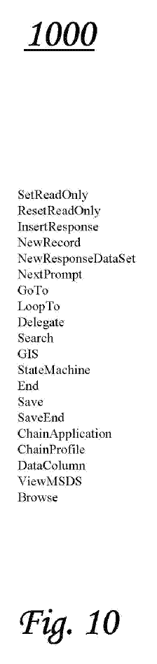

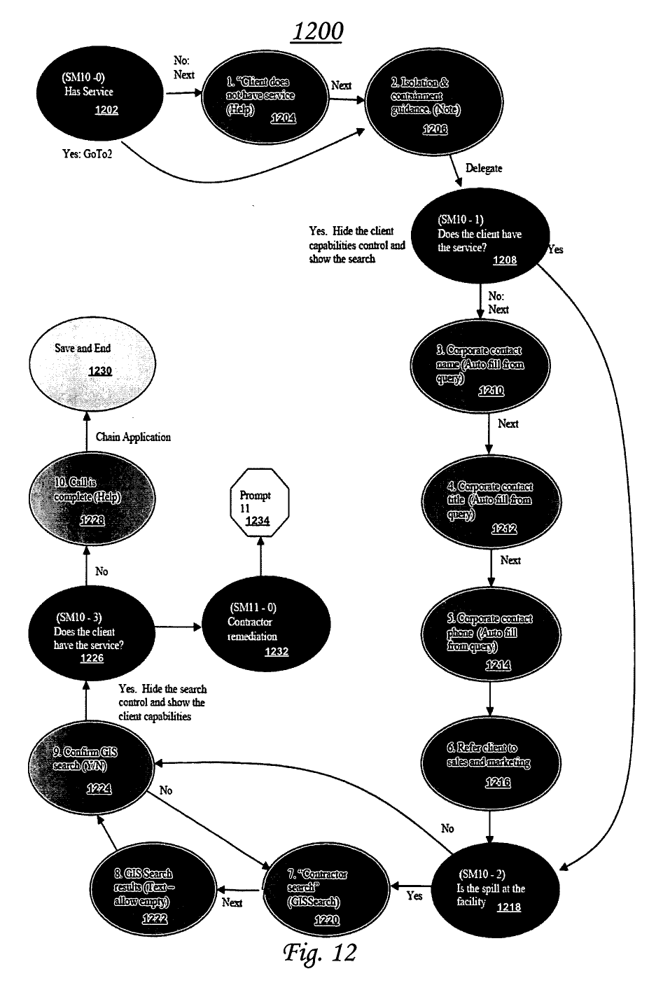

Exemplary rules for establishing the sequence of prompts are encapsulated in the state machine diagrams FIGS. 12-15. The state machine diagrams are a pictorial representation of the business rules that govern a specific process. For example, in FIG. 12 (1200): State Machine 10, State 0 (1202) is an example of business logic that evaluates the services purchased by the client. There are two transition options from the state: 1) “No” (1204) the client does not have the service, the user is given a “Help” message indicating that the client does not have the service; 2) “Yes” (1206) the client has the service, the user is directed to give isolation guidance. As the business rules (requirements) change, the changes are reflected in the state machine. The business logic and prompts can morph into the new requirements. An exemplary artificial intelligence engine module 404 according to an embodiment of the present disclosure is described in greater detail in the context of FIG. 10 below.

The database module 406 may be configured to store data pertaining to a plurality of materials events. In one embodiment, the database module 406 is based on a Microsoft Access application and database. In one alternative embodiment, the database module 406 is based on the Microsoft .Net framework and SQL2000 or SQL2005 databases, an enterprise solution. The database 406 may, for example, include entries such as federal, state and local rules that indicate how certain materials are handled, location of the material event, location of contractors handling the material events, hardware stores, transportation contractors for disposing the material, classification data such as fire code classification or waste classification for various products, inventory items which relate to a client's specific inventory, workflow status and states during the lifecycle of a materials related event and event alarms to indicate that a workflow process for a materials related event is overdue, and the like.

The search engine module 408 may be configured to search the database module 406 to retrieve materials event handling procedure data. The search engine module 408 may search the database 406 based upon metadata. The new search engine opens the entire enterprise software to the application. Criteria for any given search can be collected and assembled into a complex key by the search control 708. The complex key can then be used by the search control 708 to search the database for matching criteria. For example, a complex key consisting of a product name that contains “Sulfuric” and that is manufactured by the ABC chemical company can be assembled and used as the search criteria. Another example might be for a client location. The complex key may consist of a client that is located in the city of “Carlsbad” and the state of “California.” The search may yield 100 clients in the local area. Criteria can be added to the key to better refine the search: postal code “92069” and phone number “760.602.8700”. Since search criterion is based on metadata (i.e. any table field in the database), new criteria can be defined and implemented without touching the application. Metadata is a structured description of particular content of a data set that encodes characteristics of the information-bearing data to aid in the identification, discovery, assessment, and management of the data set. As new systems are implemented in the enterprise (i.e. the database), their structures can be exposed and searched by the application if desired. Thus, the search is not tightly coupled to the application. For example: a new service for waste classifying products may be offered. To implement the service new data structures (data tables) need to be added to the enterprise (database). The fields of the new tables (metadata) automatically become criteria that can be used by the search control. Making the search control aware of the criteria is done by means of a stored procedure in the database. Thus the search control is completely independent of the application in which it is utilized.

The location information module 410 may be configured to modify the materials event handling procedure data based on a location for the materials event. In one embodiment, the location information module 410 comprises an integrated Global Information System (GIS). The GIS may be based upon the MICROSOFT MAPPOINT web service. The GIS provides dynamic searches for point-of-interest data within a specified radius of the release location. The point-of-interest data comprises hazardous material handling contractor locations, and/or comprises hazardous material handling regulations applicable at the location. The GIS provides dynamic searches for point of interest data (e.g., hazardous material handling contractor locations) within a specified radius of the release location.

A results generation module 412 coupled to the user interface module 402 and the database module 406, is configured to retrieve materials related data from the data storage module based on the event information by querying the database module 406 with the event information to receive a material event handling procedure. The results generation module 412 is further configured to generate a materials event response based on the materials related data by presenting the material event handling procedure on the GUI.

The maintenance tool module 414 allows the user to update or modify the data and behavior of the artificial intelligence engine module 404, the database module 406, the search engine module 408, and the location information module 410. For example, certain information for the user interface module 402 may be pre-populated depending on the availability of such information. For example, where a management event inquiry request is generated by an existing service facility, that facility's identification information may be pre-populated in the form. Additionally, where the material is of a particular class of materials and information is known about that class of materials such information may also be pre-populated. Still further, where information is known about the material, but additional information may be required or desired, such known information may be pre-populated. The user can review the pre-populated information via the maintenance tool module 414 and make any edits or adjustments as necessary and fill in any additional information that is necessary or useful to complete the request. This information can be provided based on the user's knowledge and experience in the field and in dealing with particular materials. Additionally, links and other access to internal and external data repositories (e.g., federal, state, and local regulatory databases) can be provided to the user such that the user can perform any research that may be necessary or useful in completing the request.

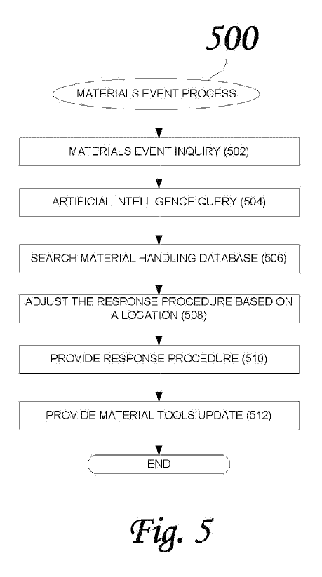

FIG. 5 is an illustration of an exemplary flow diagram of an automated hazardous materials event response management process 500 according to embodiments of the present disclosure. The various tasks performed in connection with process 500 may be performed by software, hardware, firmware, or any combination thereof. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein. For illustrative purposes, the following description of process 500 may refer to elements mentioned above in connection with FIGS. 1-4. In various embodiments, portions of process 500 may be performed by different elements of systems 100-400, e.g., a materials management center, remediation services, service sites with a centrally located or distributed automated hazardous materials event response management system including: the user interface module, the artificial intelligence engine module, the data base module, the search engine module, the location information module, the response generation module, and the maintenance tool module.

An automated hazardous materials event response management process 500 may begin by receiving a materials event inquiry from a user (task 502). For this example, the materials event is a hazardous materials event. An operator or other service personnel can receive the call from the requesting service site 306 and utilize the user interface to facilitate generation of the appropriate response. A user at a service site 306 may initiate a telephone call to a materials management center to report the material spill. These embodiments contemplate the use of conventional telephones, cellular telephones, satellite telephones, radio telephones or other telephonic instruments, including PDAs, smart phones and other electronic devices with telephonic capabilities. Alternatively, the request could also be received by a GUI directly via the user (e.g., customer at the service site). In this case, the user may access the GUI via, for example, a computer, and enter responses to prompts, for example, through a computer keyboard, a touch-screen keypad, or the like.

A request is received from a facility that is handling hazardous materials. For ease of discussion, this will be referred to as a requesting facility. In the current example, the request indicates that a particular hazardous material (or materials) has been spilled at the requesting facility. For example, a GUI will prompt for information such as the identification of the requesting facility, an identification of the person making or responsible for the request, an identification of the material or materials spilled, and other information that may be useful in responding to the event as explained in more detail in the context of FIG. 7 below.

In operation, materials management systems 100-400 receive an event from a facility or other location that it is servicing. Events can include information pertaining to a material. For example, an event can include information that a particular hazardous material has been spilled or accidentally released. In one embodiment, events deal with materials that may have particular handling, transit, cleanup, disposal, storage or other requirements such as, for example, hazardous materials.

An automated hazardous materials event response management process 500 may then query an artificial intelligence engine with response information from the user (task 504). Process 500 may dynamically change the user interface prompts depending on the information received. For example, the system will first screen the information via a GUI to determine if the user (requesting facility) has a service account, and if the user is authorized to invoke the service. If neither is the case, a new account forms may be opened for the user to prompt the user, or the user may fail at this point and may be disconnected from the system.

For example, in one embodiment, it can be determined whether the user report is coming in from an authorized or recognized service site 306. If the user is not a recognized subscriber, a script or other response can be provided on the GUI to the user telling them they have no account or asking for additional information (for example, to key in subscriber or ID information). As another example, screening may indicate that the user has an out of date account or other information that requires updating. In this case, the user can be transferred to a customer service representative or otherwise rerouted to verify and update account information or scripts can be used for automated updating and verification. In one embodiment, a by-pass can be provided such that remedial action can be taken in event of emergencies, bypassing or putting off the update process.

As still a further example, screening can be for emergency conditions that may require additional or alternative responses other than providing clean-up instructions. For example, the screening step can query the user regarding whether an injury occurred, medical treatment required, or other circumstance they may require immediate attention or alternative treatment. Thus, in one embodiment, the system can transfer the caller to a 911 response center depending on the response required.

The identification of the requester is verified. The system can be implemented to prompt the user to provide or confirm the facility and user identification. For example, the user or an employee may be prompted to enter identification code, PIN code or other identifier by a computer keypad. The user or the employee can be prompted for event type or other such information. In terms of the present example, the user could respond directly via the GUI, or calling the employee telling her/him that the event type is a material spill and provide additional information about the assistance requested. The system can prompt for additional information that may be useful in responding to the event. For example, the system can query the user regarding whether there has been blood spilled, where the spill occurred, what the weather conditions are (some spills may apply different handling based on the environment in which they occur) or otherwise query for additional information based on the event type. As a further example, in one embodiment, a tree structure can be used to walk the system and user or the employee through the appropriate queries and responses based on event type and based on subsequent responses. An exemplary embodiment of the artificial intelligence query 404 is described in more detail below in the context of FIGS. 6-12.

Additionally, communications back to the requesting facility may be conducted to obtain additional information about the spill. For example, it may be useful to determine whether the multiple materials have been co-mingled in the spill process or whether in fact they are spilled at different and separate locations at the facility yet included in a single request. In some cases, where multiple items are involved, manual intervention may be warranted to better create the appropriate response to the situation. This is because there may be combinations or conditions that are not accounted for in the various data bases.

In one example embodiment, an identification of the customer or the facility requesting the response can be made based on a facility ID or other information included in the request. For example, in Internet, networked or other computer implemented environments, login information, an IP address, cookies or other computer or terminal identification techniques can be used to identify the requesting service site 106 and, in some implementations, the particular user initiating the request.

Based on the identification, in one embodiment, information can be captured including for example, the name, employee identification number or other identification of the person initiating the request; an identification of the service site 306 from which the request was received, which can include site specific as well as chain, franchise, or other like affiliated identification; geographic location of the requesting site; contact information for the requesting person, the department involved with the event, or a service department of the service site; and return responses, including for example, fax number, e-mail address, IP address, mailing address, or other information regarding return of an appropriate response.

The appropriate information extracted from the various data repositories, information used to respond to the request is populated in various fields. For example, in one embodiment, one or more display screens are provided to an operator and include the extracted information. This information can be reviewed by the user for accuracy and completeness. Additionally, the user can update, edit, or add additional information that may be useful or necessary in responding to the request.

Automated hazardous materials event response management process 500 may then search a material handling database for a response procedure (task 506). Upon receipt of an event (for example notification that a particular material was spilled at a service facility), materials management center 302 queries the appropriate databases and records to determine information about the material and the proper handling of the materials so that appropriate responses can be generated. The system can be configured to perform a look-up or other operation based on the entered information to determine whether the material or product code exists in the database. If the information is not found, the system may prompt the user for additional information or to retry the entry. If the entry is still not found the customer can be forwarded to customer service, or prompted for additional information. If however, the material or product is located in the database, the operation can continue. Additionally, if the information is located, the user can be asked to verify the identification of the material or product searched.

In one embodiment, the database can hold customer-specific requirements or instructions that are to be used in preparing the response. For example, a customer may have particular reporting requirements to report spills or other events, a customer may have specific clean up, evacuation, or other procedures that are more stringent than those required by federal, state and local rules and regulations, and so on. If customer-specific requirements exist, those specific requirements can be retrieved and used in generating the response.

The database can also store site specific information that may exist relevant to the particular service site 306 or class of service site 306 that is making the request. For example, the service site 306 may have particular clean-up, handling, or other requirements used to address materials handling events. As another example, the location of the site may dictate particular local regulations that apply. As still another example, site specific information may dictate the form of the response (e.g., fax, email, etc.), to whom the response is sent, and so on. In one embodiment, the site identification information included with request can be used as a key to retrieve the site specific information used in generating the response to the request.

Depending on the configuration, the system can also retrieve additional information such as, for example, remediation services information. In one example, various affiliated, internal and third-party vendors and their capabilities can be included in the database to allow the system to identify and even schedule an appropriate vendor for handling the given event. For example, in the event of a spill of a particular material, one or more vendors identified as being certified or approved for handling such spills (for example, cleanup, transportation and disposal) can be identified in the database and their information retrieved in response to the request. Thus, contact and other information for these one or more vendors can be included in the response to the request. Additionally, in one embodiment, the system can automatically schedule a vendor from the approved vendor list to conduct remediation or removal activities. As a further example, a service site 306 may identify a preferred vendor or a group of preferred vendors for various services. As such, when that service site 306 is identified in a request, information regarding that particular service site's preferred vendors can be retrieved from the database.

Automated hazardous materials event response management process 500 may then adjust the response procedure based on a location of the materials event (task 508). According to an embodiment of the invention, the event response is driven by the following criteria in the order of precedence specified: 1) location specific response management, 2) account specific response management, and 3) event response management. In one embodiment, the location can be determined based on the customer identification. That is, in some embodiments, the customer identification may be specific to a customer location even where the customer is a large national or multi-national customer. For example, customer IDs can be tied to particular sites and even particular departments or locations within a site. In one embodiment, the user can be prompted to enter (e.g., via keypad) location and identification information in various formats. For example, the user may be prompted to enter an account or ID code and a security code, from which identification and location information can be determined.

The location, as with other information gathered in the course of responding to an event, can be linked to the event and associated records. Whether it is address information, latitude/longitude information, geo-codes, or otherwise, such information can be stored, associated with the event, and utilized in generating the response. This information can be used in a number of ways, including, for example, for crafting an appropriate location-specific response, directing a response team to the correct site for action (clean up, removal, attending to injuries, and so on), performing statistical analysis, record keeping and reporting.

In one embodiment the response can be adjusted or determined based on Global Information System (GIS) information and data (e.g. geo-codes), or other like data, can be used to identifying a service site 306 or event location. In such embodiments, the systems can be implemented to provide storage, retrieval, mapping, and analysis of geographic data. Spatial features can be stored in a coordinate system (latitude/longitude, state plane, UTM, etc.), to reference a geographic location on the earth. Descriptive attributes in tabular form can also be associated with spatial features. Spatial data and associated attributes in the same coordinate system can then be layered together for mapping and analysis. In one embodiment, the Global Information System is based upon the MICROSOFT MAPPOINT web service. The Global Information System provides dynamic searches for point-of-interest data (e.g., hazardous material handling contractor locations) within a specified radius of the release location. The searching step is performed by a search engine designed to search the entire database based upon metadata.

Once the location is determined, the system determines whether there are location-specific rules, regulations or other instructions that need to be applied in responding to the request. In one embodiment, the system can also determine the capabilities of the requesting facility to handle the materials event. For example, state and local authorities often have different requirements for dealing with particular materials than their neighboring states and localities. Therefore, it is useful to determine whether and which particular regulations may apply in a given circumstance based on the location of the event. It may also be important to determine the location of a receiving site in the circumstance where the event is the transportation of the material from a first location to a receiving location. In this way, requirements for each location can be determined.

Automated hazardous materials event response management process 500 then provides a response to the materials event based on the determined response procedure (task 510). According to one embodiment, the response may be in the form of a referral to a remediation service provider, dispatch of a remediation service provider, or instructions for cleanup procedure. The responses are not limited to these responses but can include additional information, actions, and output as would be appropriate for the given application or environment. The data is reviewed to determine whether there is more than one item of material that needs to be addressed. This can be useful, for example, in the context of spilled hazardous materials, as the mixing of multiple hazardous materials may result in a different set of conditions than the spillage of either one of the materials and thus may require different handling techniques, precautions and procedures. If on the other hand, however, there are additional materials included in the request, additional data may need to be extracted and reviewed to determine the appropriate manner in which to handle the combined materials. The capabilities of the requesting facility to handle the materials event are evaluated. For example they may possess personal protective equipment (PPE) required to handle the spilled material. On the other hand, they may not possess the required PPE. They may have waste storage facilities at the facility or they may not. The response procedure can be transmitted to the requester at the appropriate location. For example, as described above, the information can be transmitted via facsimile, mail, text messaging, the internet or other network, or any other means as may be useful or appropriate for transmitting requested information.

Instructions can include information such as, for example, specific information regarding the steps to follow in cleaning up the particular hazardous material that has been spilled, appropriate methods and techniques to store the spilled material, ways to treat the environment in which the material was spilled, methods for treating individuals that may have been exposed to the spilled material, and other like information and instructions. For example, as explained above, if event indicates that chlorine was spilled at a given facility, the instructions can include information to the facility such as to restrict access to the area until cleanup is completed, that the chlorine can be harmful if exposed to the skin and can also emit a poisonous gas, that the appropriate NIOSH/MSHA-approved full face positive pressure respirator and protective clothing should be worn (which can also be identified in the instructions), and that persons without suitable respiratory and body protection must leave the area. The instructions might also include information regarding the U.S. Department of Transportation (DOT), evacuation and transportation guidelines and the appropriate handling of containerized waste chlorine in accordance with applicable federal, state, and local health and environmental laws and regulations.

In another example where an event is not a spill of a hazardous material but instead the usage of a hazardous material, the instructions might include information on how to safely handle, use and dispose of a particular material. For example, information on whether effective ventilation should be provided, respiratory protection that should be used, eye and face protection that should be used, whether skin protection should be used, whether to avoid eating, drinking, and smoking in work areas, and so on.

Additionally, as yet another example, instructions can include special precautions for material handling and storage of the hazardous materials. For example, the information can include instructions on proper containers in which to store the material, appropriate temperature ranges for the environment in which the material is stored, incompatibility with other materials for storage, proper labeling for storage containers, shelf life or storage limits for the material, and other like information. As these few examples serve to illustrate, a variety of instructions and information can be provided to a requesting facility to provide them with the appropriate instructions for dealing with any of a number of different events.

Automated hazardous materials event response management process 500 may also provide maintenance tools updates (task 512). The maintenance tools can update the database 406 to maintain a record of the events that transpired. For example, information pertaining to the date and time of the event, the facility at which the event occurred and its location, an identification of the material or materials involved, quantities of materials involved, actions recommended and taken, event closure and other such information can be recorded in the database for record keeping, reporting, and statistical analysis purposes. As with the other events described herein, the appropriate databases can be updated such that new materials information, new regulations, historical analysis, statistical analysis, recordkeeping and reporting abilities can be maintained. This example serves to illustrate how similar events can take place to schedule the cleanup or other remediation activities as well as other system events such as reporting. Event playback can be a part of the event lifecycle. The contents of the conversation, including the prompts, the response and the advice given may be beneficial for litigation or other purposes of a historical nature. Data entered via the GUI is collected and can be played back in an identical fashion in which it was taken. Data collected via voice communication is recorded and stored for playback.

FIGS. 6-15 illustrate the preferred embodiment according to the present disclosure following the process of the automated hazardous materials event response management process 500 (see FIG. 5). The example process for the preferred embodiment begins with the user interface in a blank state as shown FIG. 6. In one example embodiment, a .Net software component used for the blank state is a panel 602 provide by a GUI. A user fills in the response according to the prompts of the artificial intelligence engine 404 (see FIG. 4), and the application drives him/her through the succession of prompts that correspond to the particular materials event as shown in FIG. 7 (representing a materials event query 502 in FIG. 5).

FIG. 7 illustrates an exemplary user interface 700 that can be further configured to prompt for product information such as material identifier, quantity involved in the event (e.g., amount spilled), and so on. The user interface 700 can be configured to identify the product or material that was spilled and thus provide tailored responses to the requester. For example, in one embodiment, the system can prompt for a UPC, site-specific or customer-specific code, product name, product description, product class, or other information that might be used to identify the materials involved in the spill. The responses can be numeric or alpha-numeric—for example, via a keypad. Additional queries can be made for additional information based on the information provided.

The user interface 700 can be used to facilitate the event generation and response delivery in any of a number of different types of events for various scenarios and operations. A screen can be provided on user interface 700 to allow this system to display step-by-step instructions to the user regarding how to handle a particular event such as, for example, cleanup instructions, safety instructions, material handling instructions, and so on. Additionally, a user interface 700 can be used to track the movement of materials throughout the material handling process. For example, when a spilled material is tendered to the appropriate transporter for removal and ultimate disposal, that event can also be logged by user interface 700.

Each successive prompt is dynamically created based upon the data collected in the previous prompts and contains three primary features: 1) the prompt field 702, 2) the response field 704, and 3) an information hint field 706. The search control window 708 is designed as an interactive component with the application. The fields of the data tables (metadata) in the database become search criteria that can be used by the search control. The search control is integrated with other components included in the application, such as the controls 702/704/706, and state machines that have been implemented in code by means of a DELEGATE method, or CALLBACK method. When the desired search result is found, generally by double-clicking the mouse on one of the search results items in the search control (708), the DELEGATE method communicates or calls back to the component that initiated the search with the results of the search. For example, in FIG. 7 a search is initiated for a specific store by its “LocationAlias.” The user enters 1001 into the field as the alias and a unique value is returned, Store 1001. If there are multiple stores that begin with 1001, multiple results would be returned. When a unique value is selected, the search control then communicates the information back to the controls 702/704/706 and the billing location is automatically populated into the proper field. The Call-back phone number is also populated.

In this example embodiment, the prompt field 702 includes questions such as client's abbreviation, account location, billing location, client information (e.g., name, address, phone number, and title), whether this incident is a follow-up to a previous incident, name of the employee receiving the information, date and time on which the materials event (e.g. spill) occurred, and the like. The response field 704 includes the answers to questions prompted in the prompt filed 702. The information hint 706 is used for training purposes to familiarize the operator or the user with the prompt/response procedures.

In most cases, data entry is mouse free. Although drop-down lists and other mouse activated components can be used, they are more often used as information hints. This is valuable during the training phase, but as the user learns the contents of the list, data entry can be driven by typing the first character of the list item. Data entry simulates typewriter input.

Mouse free data entry and scrolling prompts allows for streamlined data entry and virtually unlimited screen real-estate. The user does not need to traverse different applications, screens or tabs to accomplish his task. Prompt profiles can be revised and chained, thus the application can grow to accommodate new requirements as they arise. End user training is simplified. The user simply follows a script that is provided to him. When the response field is populated, data entry is accepted by pressing the enter key. As prompts are added to the prompt field 702 (see FIG. 7), preceding prompts scroll out of the user's view. They are still available for reference by the user via the scroll bar. Prompts continue to be added until the incident is completed.

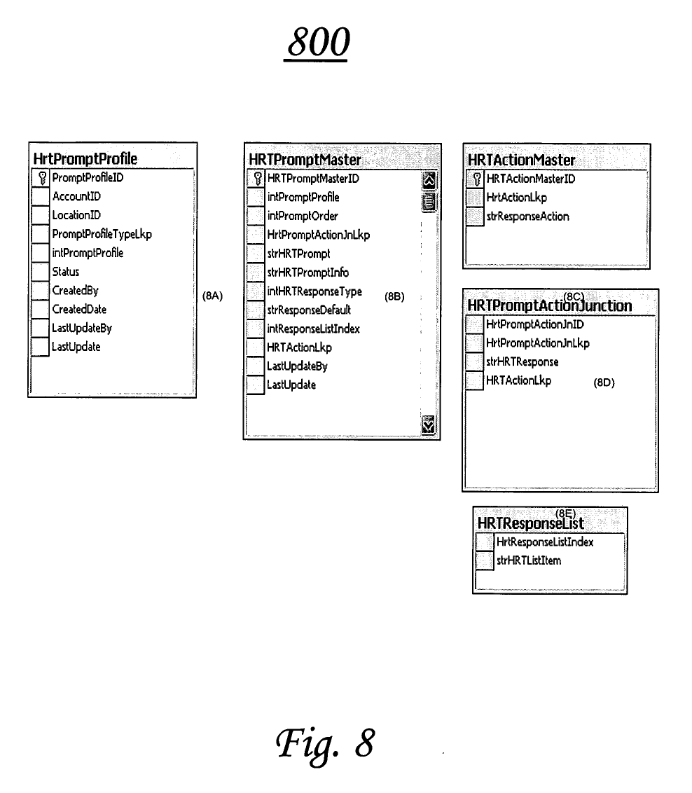

FIGS. 8A-8E show exemplary tables used for prompt profiles according to the embodiments of the present disclosure used to populate the user interface of FIG. 7. Prompts and prompt profiles are defined as data and metadata in the database. FIG. 8A shows a HrtPromptProfile table containing the different prompt profiles for each Account/Location. FIG. 8B shows HrtPromptMaster table containing metadata for each prompt in the profile. FIG. 8C shows HrtPromptActionJunction table containing decision branching criteria for prompts. FIG. 8D shows HrtActionMaster table containing stock actions available for each prompt, and FIG. 8E shows HrtResponseList table containing plain text and list material for display as hints.

For example, a prompt profile for each account/location (AccountID/LocationID) is defined in the HrtPromptProfile table (FIG. 8A). When a new profile is created, it is assigned a type, PromptProfileTypeLkp, for example “Hrt Client Search.” When the profile type is assigned to an account/location it is given a profile number, intPromptProfile. A specific profile can be created and tailored for each account/location pair. In this way, the same prompt type can be used for multiple account/locations and be tailored for each individually. A profile is loaded at runtime by its type, AccountID and LocationID.

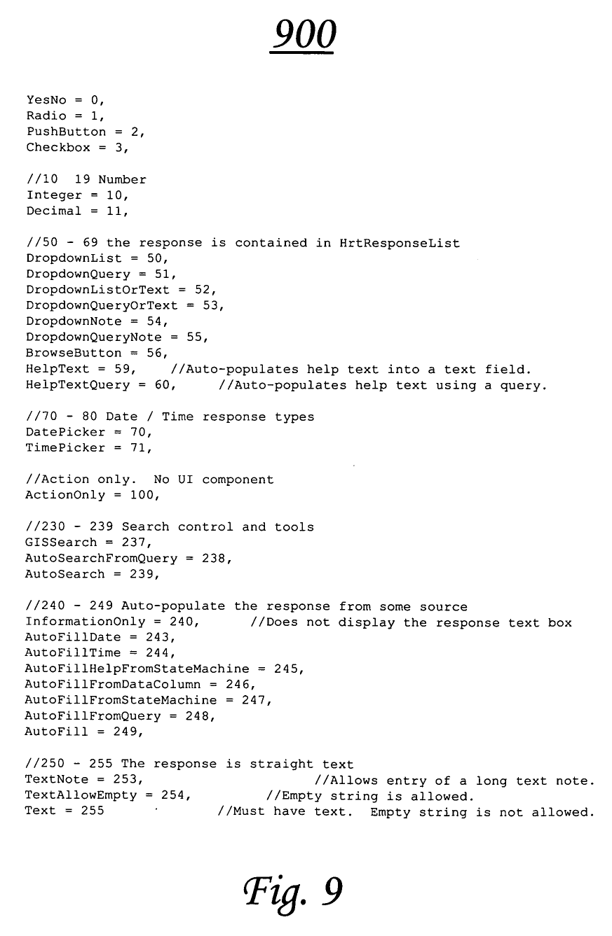

The HRTPromptMaster (see FIG. 8B) contains metadata for each prompt in all of the profiles. Each row of the table in FIG. 8B contains metadata to create a prompt/response pair and is defined by the following six fields: 1) strHRTPromp, 2) strHRTPromptInfo, 3) intHRTResponseType, 4) strResponseDefault, 5) intResponseListIndex, and 6) HrtActionLkp. intPromptProfile is a unique profile identifier for a set of prompt/response pairs. intPromptOrder is the order in which the prompts will be displayed. strHRTPromp is a Text field which is a prompt that the end user will see, strHRTPromptInfo is a Text field which contains a brief description, or hint, of the information required, intHRTResponseType is an Integer which is the type of response expected (see FIG. 9 for a list of different response types), strResponseDefault is a Text field where a default response that can be defined, intResponseListIndex is an Integer and it is an index to a list if the response type is a list type, and HrtActionLkp is an Integer which is the action if the default response is accepted. HRTActionMaster (see FIG. 8C) is a table that contains all of the pre-defined stock actions that can be taken when a response is entered. An example of different actions is defined in FIG. 10. For example, one stock action is “NextPrompt.” When the response is entered, the next prompt in the profile sequence is displayed. (See FIG. 12 (1210) (1212) (1214) (1216)). Another stock action is “Delegate.” In this case, when the response is entered, the action is delegated to some business logic that has been implemented in code in a state machine. For example in FIG. 12 (1206) the user is prompted to enter a note. When the response has been entered, the “Delegate” action is taken and state machine 10, state 1 is executed in code (1208). A default action can be defined for any prompt/response pair. This is done by setting the value for the HRTActionLkp field in the HRTPromptMaster table. When the response is entered the corresponding action in HRTActionMaster is taken.

HRTPromptActionJunction (see FIG. 8D) is a table that is used when more than one action is required for a given prompt/response pair. For example the response to an exemplary prompt may be “Yes” or “No.” If the response is “Yes” the “NextPrompt” action is be taken, but if the response is “No” a “Delegate” action is taken. This behavior is captured in the HRTPromptActionJunction (8D) table. In such a case, the HrtPromptActionJunctionLkp field in HRTPromptMaster (8B) is used to look up the list of available actions in the HrtPromptActionJunction (8D) table. The response that was entered is matched to the strHRTResponse field in the HrtPromptActionJunction (8D) table and the appropriate action is taken. The HrtResponseList (8E) table is used to contain lists of possible responses. It may be desired to present an information hint as a list of items from which the user can select. In FIG. 7 (706) this is shown as a dropdown list beside the prompt “Select client's title:” The list is filled with items contained in the HrtResponseList (8E) table. When a list type prompt is created (see FIG. 9) an entry is made in the intHrtResponseListIndex field in the HRTPromptMaster (8B) table. The list items are extracted from the HrtResponseList (8E) table using this key and the dropdown list in the information hint field (see FIG. 7 (706)) is populated with the items.

FIG. 9 shows an exemplary computer code for prompt/response pair according to the embodiments of the present disclosure. Each prompt must have a respective response type defined by intHRTResponseType (see FIG. 8). Each response type must be implemented in the application. Validation rules for each response type are enforced by the application. For example: a response type of “Yes” or “No” (see FIG. 9) may be used for the prompt: “Is this a follow-up to a previous incident (y/n)” (see FIG. 7 (702)). If the user makes any response other than “Yes” or “No” the validation rules will trap the invalid condition and prohibit the response.

The response types have been defined as enumeration constants in the solution as described in FIG. 9. Prompts are created and visually presented at runtime based upon its type and corresponding metadata. The behavior of the prompt is also dictated by the metadata. For example, if the response type is a DropdownList or DropdownQuery (see FIG. 9), a list of selections is presented to the user. intResponseListIndex (see FIG. 8E) keys into the HrtResponseList table (see FIG. 8E) where the list can be obtained. If the response type is DropdownQuery (see FIG. 9), the list is obtained by running a stored procedure. A stored procedure is a database object that executes data access code and is stored in the database. Typically it is written by a DBA (Database Administrator) or other individual familiar with data access programming. In this case the stored procedure, when executed, returns a result set consisting of a list of items and the dropdown list in the information hint field (see FIG. 7 (706)) is populated with the items. The name of the stored procedure used to obtain the list is returned from the HrtResponseList table (see FIG. 8E) instead of a list of items. The stored procedure is then executed to retrieve the list.

Data collection and processing occurs when a valid response corresponding to a prompt is entered. Action is taken based upon the response. FIG. 10 is an example of stock actions that can be assigned to any response. The actions are defined in the HRTActionMaster table (see FIG. 8C) according to an embodiment of the disclosure. The action represents a transition from one state in the data collection process to another state. Following is an explanation of what each action call does in accordance to one embodiment of the invention:

SetReadOnly—Sets the text in the response field and all subsequent response fields to Read Only.

ResetReadOnly—Resets the SetReadOnly bit.

InsertResponse—Inserts a response into the Response Data Set

NewRecord—Creates a new record in the Response Data Set

NewResponseDataSet—Creates a new instance of the Response Data Set. This data set is used to collect responses as they are entered in the prompt/response profile. They can be played back later.

NextPrompt—Puts the next prompt in the prompt profile sequence into the control.

GoTo—Go to the prompt number specified. Used for branching actions. If the prompt number is less than the current prompt number, remove all prompts and begin with the specified prompt number.

LoopTo—Same as GoTo. Used for setting up data collection loops. If the prompt number is less than the current prompt number, the prompts are not removed, the profile continues with the specified prompt number.

Delegate—Calls a state machine to evaluate the response and execute the action.

Search—Sets up and initializes the search control for a database search

GIS—Launches the GIS (Global Information System) web site

StateMachine—Runs a new state machine

End—Ends the profile and re-initializes the application.

Save—Saves the information in the current profile

SaveEnd—Saves the information and re-initializes the application

ChainApplication—chains a new application to the current profile. A new state machine is created to run the prompts.

ChainProfile—chains a new profile to the current profile. Does not create a new state machine to run the prompts.

DataColumn—the response for the current prompt is filled with the data in the first row of a data table having the column number specified.

ViewMSDS—launches the MSDS sheet in a pdf viewer

Browse—Launches a web browser with the URL specified in the HrtResponseList table.

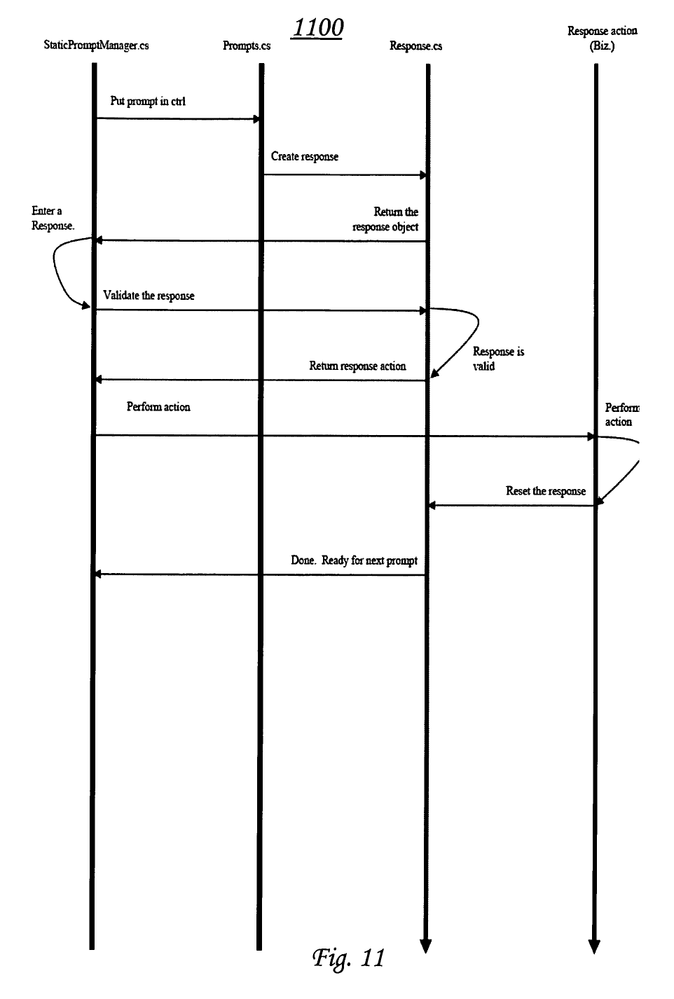

An event trace diagram for a prompt/response sequence is shown in FIG. 11. A set of prompts is retrieved from the HrtPromptMaster table (8B) based on the prompt profile desired. A static prompt manager module (StaticPromptManager.cs) sends a command to create a prompt to a prompt module (Prompts.cs), which in turn sends a command to create a response object to a response module (Response.cs), the response object is returned to the static prompt manager module (StaticPromptManager.cs) and the prompt/response pair and information hint is displayed to the user on the user interface (see FIG. 7). The application waits for the user to enter a response to the prompt. When the response is entered, it is validated by the response module (Response.cs). After validation, the response action is performed by the static prompt manager module (StaticPromptManager.cs), and the prompt/response sequence returns to the next prompt.

Custom profiles can be easily created for different materials event types or client needs using the maintenance tool module 414. The prompt profile for any account/location pair can be changed and new or existing prompts can be added to a profile by using the maintenance tool module 414. Tools to support the underlying data structures can be as simple as a spreadsheet or as sophisticated as a drag and drop visual wizard. The maintenance tool can itself be a prompt/response profile. The maintenance tool allows the user to build custom profiles for any account or location in our enterprise. Metadata for each prompt can change within the limits of the design and the changes will be reflected dynamically in the application behavior without recoding or rebuilding the application.

Custom profiles vary depending on the company, the incident, the location and responses to questions asked. This leads to greater accuracy of data collection and remediation measures recommended. For example, an account “Scott's Super Sauce” may require answers to a spill incident on an account level but each store for Scott's Super Sauce may have additional questions they would like answered and documented based on their location. Further, “Scott's Super Sauce Supply” may have a different prompt profile than “Scott's Super Sauce USA”. The finest granularity for a prompt profile is an account (AccountID)/location (LocationID) pair.

As explained above, the artificial intelligent engine module 404 dynamically builds the succession of prompts based on response data collected in previously received responses. Data collection for each materials event may vary depending on the company, the materials event, the location and responses to questions asked by the user. The data collection solution utilizes artificial intelligence (AI) engine module 404 to drive the sequence of questions and actions by the user based upon these criteria.

In an exemplary embodiment, the AI engine module 404 is presenting the user with a series of prompts, or questions and receives corresponding responses or answers to the prompt. Profiles of prompts are established by the business rules and process flow for a materials event, the same prompts can be used for many different customers. In this example embodiment, the AI engine module 404 for data collection is implemented as a series of state machines. Each prompt/response pair represents discrete states in the machine. Decision branching is represented as a state transition from one state to another. State transition criterion is evaluated at run-time and is driven by underlying data in the enterprise and the operator's responses to the prompts. The next prompt/response pair is dynamically created at runtime based on the state transition criterion. State management for the AI engine module 404 and state diagrams representing the data collection process for a materials event are described in more detail in the context of FIGS. 12-15 below.

Business rules for each response are developed in the application. Simple business rules can be maintained in the profile itself. For example, in many cases the action for a response is simply to go to the next prompt. Complex business rules are developed in code. Each prompt can delegate its action to a specific State Machine and State in the application code. This is done by executing the stock action “DELEGATE,” that is, the action for a valid response to the prompt is “DELEGATE.”

When the “DELEGATE” action (see FIG. 10) is called, a corresponding state machine and state are created by the application. This is done by the state machine factory class called StateMachineManager. The state machine factory class is responsible for creating and managing the state machine that is requested by the “DELEGATE” action in the profile. Each state machine follows a specific design pattern. The state machine is always in one unique state. In that unique state, the state machine can perform some atomic action-business logic that processes the response to the prompt. Once the atomic action is executed, the state machine can then transition to other states in the state machine, or it can transition to another state machine entirely.

In this example embodiment, each state machine is instantiated with the panel that contains the active prompt profile. When the “DELEGATE” action is executed by a valid response to a prompt, a state transition is made in the state machine. The response for the prompt is passed into the state transition method as an argument. The response is evaluated, the complex business logic is applied and control is returned to the user by putting the next prompt into the control based on the application of the business rules. In this way a complex artificial intelligence is built into the application. Since execution of the business rules is very atomic in nature, the response of the control is very fast. The prompt can also “DELEGATE” its action to an entire state machine. In this case the “DELEGATE” is not a state in a state machine, but an entire state machine.

According to an example embodiment of this disclosure, each prompt represents a unique state in the data collection process. A response to the prompt represents a state transition. Based on the response and the action required for the response, the system makes a transition to another unique state in the data collection process, a new prompt. A prompt/response pair is architected to model a Finite State Machine (FSM). State machine design is a common software development paradigm that would be apparent to one of an ordinary skill in the art. Therefore, the detail of a finite state machine design is not explained herein. An example of a state machine that represents an emergency response profile is shown in FIGS. 12-15.

FIG. 12-15 illustrate a state machine according to an exemplary embodiment of this disclosure for typical prompt response profiles. States labeled “SM” represent states that are implemented in code. For example in FIG. 12, the first state in the diagram evaluates whether the client has the emergency response service. Since this is complex business logic it is implemented in state machine 10 state 0 (SM10-0). If the client does not have the service it causes a transition to prompt #1, a message to a user. If the client does have the service, the message is skipped and prompt #2 is displayed. The user then navigates through the emergency response profile dependent upon the prompt, the response and the underlying business logic. A state machine according to an exemplary embodiment of this disclosure for an exemplary prompt response profile is shown in FIG. 12 below.

FIG. 12 represents an exemplary state machine for an automated hazardous materials event response management process including: a materials event query (502 in FIG. 5), artificial intelligence engine query with response information from the user (504 in FIG. 5), searching a material handling database for a response procedure (506 in FIG. 5), and adjusting the response procedure based on a location of the materials event (508 in FIG. 5). The state machine begins with determining if the user has service (state 1202); if not, a message is sent to the user (e.g., no account) (state 1204), if yes the state machine goes to state 1206 where the containment guidance is given. Next, state 1208 determines the actions depending on whether the user has service: if no, a corporate contact name (state 1210), title (state 1212), and phone number (state 1214) prompts are added to the user interface (see GUI in FIG. 7) and the client is referred to sales and marketing (state 1216). Next, state 1218 determines if the material event (spill) is at the user's facility: if no, state machine goes to state 1224, if yes, a search is made to a GIS database (state 1220), results are returned (state 1222), and the GIS search results are confirmed (state 1224). Next, state 1226 determines actions depending upon if the user has service: if no the call is terminated (state 1228) and saved (state 1230); if yes the state machine proceeds with contractor remediation (state 1232) at prompt 11 (state 1234).

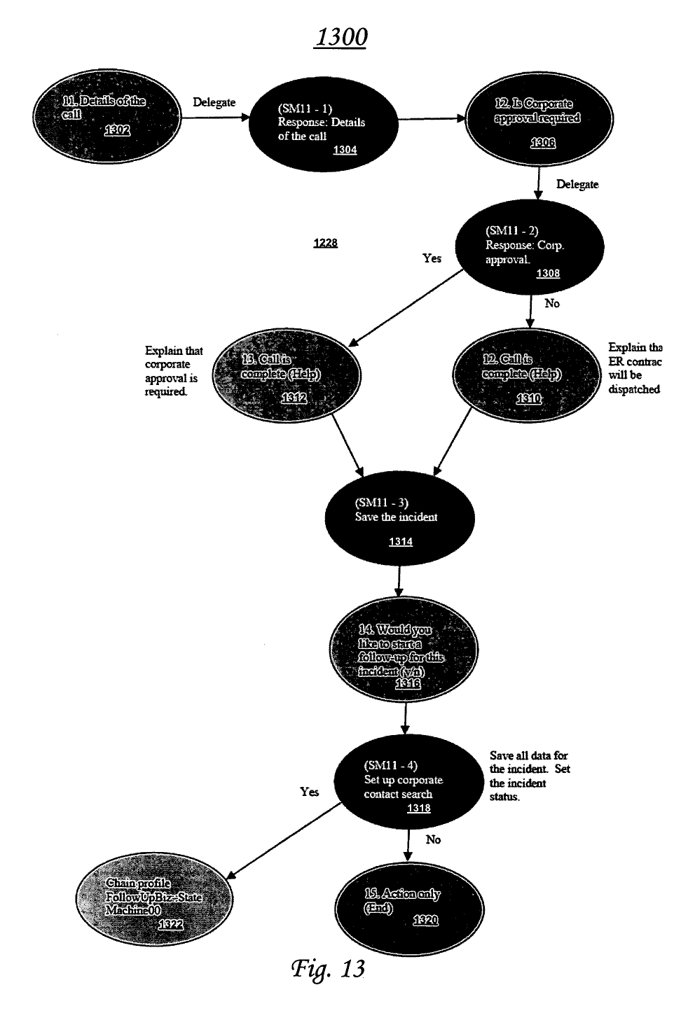

FIG. 13 continues the state machine 1200 of FIG. 12 from prompt 11 (state 1234 in FIG. 12 and state 1302 in FIG. 13). Prompt 11 (state 1302) delegates to state 1304 which captures the details of the call. Next a prompt is displayed to determine if corporate approval is required (state 1306) based on the result (state 1308); if no, the call is complete (state 1310), if yes, the user is informed that corporate approval is required and the call is completed (state 1312), and the incident is saved (state 1314). Next, a follow up can be initiated by the user (state 1316). If corporate approval is required a workflow and alarm are set to trigger a corporate contact search (state 1318). If the user would like to begin a follow up call a new state machine is created and the follow-up profile is made (state 1322); if not the session is ended (state 1320).

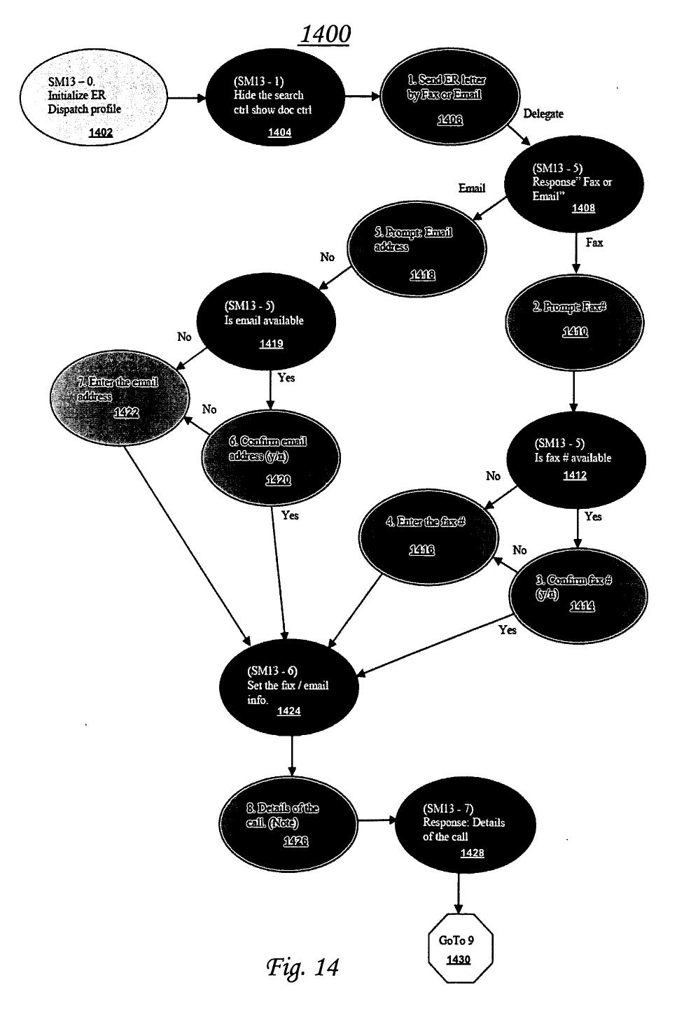

FIG. 14 represents an exemplary state machine 1400 for an automated hazardous materials event response management process including providing a response to the materials event based on the determined response procedure (510 in FIG. 5). The response begins by starting a dispatch profile (state 1402). Next, the user interface is reconfigured to show dispatch document control (state 1404). The user is queried (state 1406) whether the response dispatch should be sent by email or fax (state 1408). If a fax is requested, then a fax number is prompted for the user (state 1410), if the fax number is available (state 1412) then the fax number is confirmed (state 1414) otherwise the fax number is entered (state 1416), and the fax information is set (state 1424). If an email is requested, then an email address is prompted for the user (state 1418), if the email is available (state 1419), the email is confirmed (state 1420) otherwise the email address is entered (state 1422) and the email information is set (state 1424). Next, notes on details of the call are requested (state 1426), details of the call may be given, (state 1428), and the state machine proceeds to state 1430.

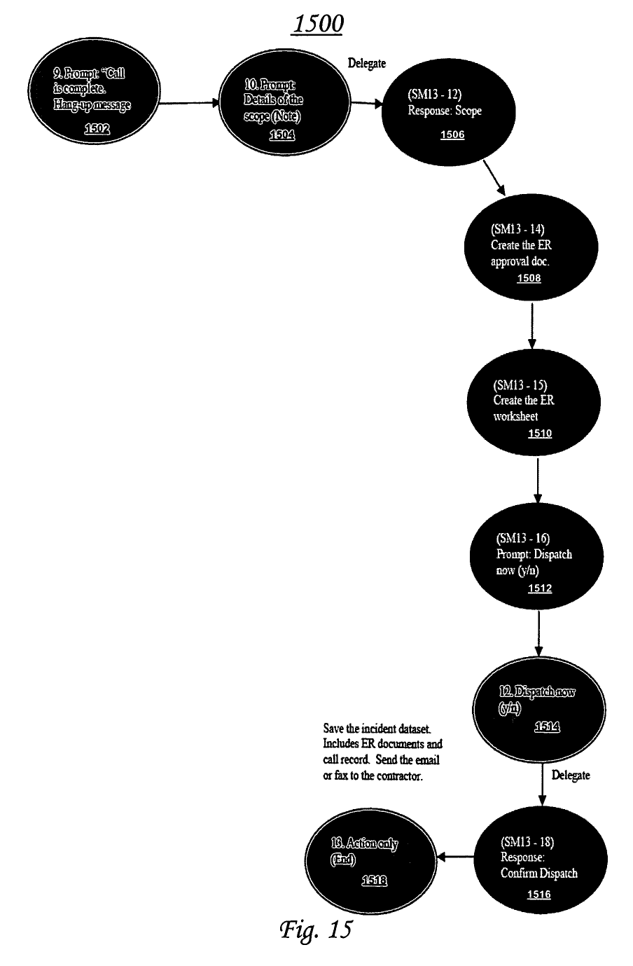

FIG. 15 continues the state machine of FIG. 14 from state 1430 in FIG. 14 which is state 1502 in FIG. 15). State 1502 begins follow up after a call is complete including: scope (state 1504) and (state 1506), creating an emergency response (ER) document (state 1508), creating an ER worksheet (state 1510), prompting for dispatch approval (state 1512), receiving dispatch approval (state 1514), confirming dispatch (state 1516), and ending (state 1518).

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the disclosure, whether or not such embodiments are described and whether or not such features are presented as being a part of a described embodiment. Thus the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Although embodiments of the present disclosure are described herein in terms of hazardous materials, it should be understood that the present disclosure is not limited to hazardous materials, but is generally applicable to material handling. Furthermore, although the present disclosure has been fully described in connection with embodiments thereof with reference to the accompanying drawings, it is to be noted that various changes and modifications will become apparent to those skilled in the art. Such changes and modifications are to be understood as being included within the scope of the present disclosure as defined by the appended claims.

What is claimed is:

1. A materials event response system, comprising:
a user interface module configured to prompt a user for event information pertaining to a materials event, and receive the event information from the user;
an artificial intelligence engine module configured to modify behavior of the user interface module based on the event information received from a user;
a database module configured to store data pertaining to a plurality of materials events in a database; and
a search engine module configured to search the database module to retrieve materials event handling procedure data.

2. The materials event response system of claim 1, further comprising a location information module configured to modify the materials event handling procedure data based on a location for the materials event.

3. The materials event response system of claim 1, further comprising a results generation module, configured to generate a materials event response based on the retrieved materials related data.

4. The materials event response system of claim 1, wherein the materials event comprises a hazardous materials event.

5. The materials event response system of claim 2, wherein the location information module comprises an integrated Global Information System.

6. The materials event response system of claim 5, wherein the integrated Global Information System is based upon a MICROSOFT MAPPOINT web service.

7. The materials event response system of claim 5, wherein the integrated Global Information System provides dynamic searches for point-of-interest data within a specified radius of the location for the materials event.

8. The materials event response system of claim 7, wherein the point-of-interest data comprises hazardous material handling contractor locations.

9. The materials event response system of claim 7, wherein the point-of-interest data comprises hazardous material handling regulations applicable at the location of the materials event.

10. The materials event response system of claim 1, wherein the search engine module searches the database based upon metadata.

11. The materials event response system of claim 1, further comprising a maintenance tool module, to allow the user to modify the data and behavior of the artificial intelligence engine module, the database module, the search engine module, or the location information module.

12. A method for responding to a materials event, the method comprising:
receiving a materials event inquiry from a user;
querying an artificial intelligence engine with response information from the user, wherein the artificial intelligence engine is configured to prompt the user for the response information, and changing behavior based upon the response information; and
searching a material handling database for a response procedure.

13. The method of claim 12, wherein the materials event comprises a hazardous materials event.

14. The method of claim 12, wherein the querying step further comprises screening the user for account information.

15. The method of claim 12, wherein the querying step further comprises opening a new account for the user.

16. The method of claim 12, wherein a location of the materials event is determined from an integrated Global Information System.

17. The method of claim 16, wherein the integrated Global Information System is based upon a MICROSOFT MAPPOINT web service.

18. The method of claim 16, wherein the integrated Global Information System provides dynamic searches for point-of-interest data within a specified radius of the location of the materials event.

19. The method of claim 18, wherein the point-of-interest data comprises hazardous material handling contractor locations.

20. The method of claim 18, wherein the searching step is performed by a search engine designed to search the material handling database based upon metadata.

21. The method of claim 12, future comprising a step of adjusting the response procedure based on a location of the materials event.

22. The method of claim 21, wherein the step of adjusting further comprises changing the response procedure according to regulations applicable at the location of the materials event.

23. The method of claim 12, further comprising maintaining the artificial intelligence engine and the material handling database with maintenance tools.

24. The method of claim 23, wherein the maintenance tools may update the artificial intelligence engine and the material handling database according to new regulations.

25. The method of claim 23, wherein the maintenance tools may update the artificial intelligence engine and the material handling database according to new materials information.

26. The method of claim 12, wherein the changing behavior comprises dynamically building a succession of prompts based on data collected in previously received responses corresponding to the materials event.

27. The method of claim 12, further comprising generating a response to the materials event based on the response procedure.
